(19) United States
(12) Patent Application Publication
(10) Pub. No.: US 2023/0419526 A1
(43) Pub. Date: Dec. 28, 2023

(54) METHOD, APPARATUS, AND COMPUTER-READABLE MEDIUM FOR ROOM LAYOUT EXTRACTION

(71) Applicant: GEOMAGICAL LABS, INC., Mountain View, CA (US)

(72) Inventors: Konstantinos Nektarios Lianos, San Francisco, CA (US); Prakhar Kulshreshtha, Palo Alto, CA (US); Brian Pugh, Mountain View, CA (US); Luis Puig Morales, Seattle, WA (US); Ajaykumar Unagar, Palo Alto, CA (US); Michael Otrada, Campbell, CA (US); Angus Dorbie, Redwood City, CA (US); Benn Herrera, San Rafael, CA (US); Patrick Rutkowski, Jersey City, NJ (US); Qing Guo, Santa Clara, CA (US); Jordan Braun, Berkeley, CA (US); Paul Gauthier, San Francisco, CA (US); Philip Guindi, Mountain View, CA (US); Salma Jiddi, San Francisco, CA (US); Brian Totty, Los Altos, CA (US)

(21) Appl. No.: 18/213,115

(22) Filed: Jun. 22, 2023

Related U.S. Application Data
(60) Provisional application No. 63/354,608, filed on Jun. 22, 2022.
(60) Provisional application No. 63/354,596, filed on Jun. 22, 2022.

(51) Int. Cl. G06T 7/60; G06T 7/12; G06T 7/536

(52) U.S. Cl. CPC G06T 7/60; G06T 7/12; G06T 7/536; G06T 2207/10024; G06T 2207/20164

(57) ABSTRACT

A method for layout extraction is provided. The method can include storing a plurality of scene priors corresponding to an image of a scene, detecting a plurality of borders in the scene, generating a plurality of initial plane masks and a plurality of plane connectivity values based at least in part on the plurality of borders, and generating a plurality of optimized plane masks by refining the plurality of initial plane masks based at least in part on an estimated geometry of the plurality of layout planes.

### RELATED APPLICATION DATA

This application claims priority to U.S. Provisional Application No. 63/354,596, filed Jun. 22, 2022, and U.S. Provisional Application No. 63/354,608, filed Jun. 22, 2022, the disclosure of which are hereby incorporated by reference in their entirety.

### BACKGROUND

Recreating a physical scene is useful for various user applications, including gaming and interior design and renovation. An aspect of the physical scene is the architectural layout, including one or more walls, floors, and ceilings. Advances in augmented reality, deep networks, and open-source data sets have facilitated extracting single-view room layout extraction and planar reconstruction. However, contemporary technology can be limited in accurately capturing a scene.

Layout extraction of a scene can utilize images taken on a user device, such as a smartphone. Piecewise planar reconstruction methods for layout extraction can attempt to retrieve geometric surface planes from the images, which can be single views or panoramic views. The quality of the layout extraction can depend on the technology equipped with the smartphone. For example, some smartphones only utilize 2D red-green-blue (RGB) images, which can propagate layout extraction challenges, such as repeating textures, or large low-texture surfaces, that can hinder the perception of 3D surface geometry, using conventional methods. Some smartphones may ignore field of contextual, or perceptual information, available to accurately reconstruct a scene. Some smartphones might not accurately capture complex geometries that can include corners, curvatures, and other architectural features, for example. In addition to camera limitations, technology can operate under certain assumptions about a room that impair layout extraction, such as assuming the room is strictly rectangular, that corners are visible and not occluded by furniture or other items, and that walls or other surfaces do not contain openings or architectural features, such as arches, columns, or baseboards.

Accordingly, there is a need for improvements in layout extraction systems and methods.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a existing layout extraction.

FIG. 2 illustrates existing layout extraction.

FIG. 3 illustrates a layout extraction according to an exemplary embodiment

FIG. 4 illustrates a method for layout extraction according to an exemplary embodiment.

FIG. 5 illustrates an Input image of a scene according to an exemplary embodiment.

FIG. 6 illustrates a semantic map of a scene according to an exemplary embodiment.

FIG. 7 illustrates a line segment scene prior according to an exemplary embodiment.

FIG. 8 illustrates an edge map scene prior according to an exemplary embodiment.

FIG. 9 illustrates a depth map scene prior according to an exemplary embodiment.

FIG. 10 illustrates a photogrammetry points scene prior according to an exemplary embodiment.

FIG. 11 illustrates a normal map scene prior according to an exemplary embodiment.

FIG. 12 illustrates first scene prior inputs and initial plane mask and plane equation outputs according to an exemplary embodiment.

FIG. 13 illustrates second scene prior, initial plane mask, and connectivity value inputs and optimized plane mask outputs according to an exemplary embodiment.

FIG. 14A illustrates a method for layout extraction according to an exemplary embodiment.

FIG. 14B illustrates the method for layout extraction of FIG. 14A.

FIG. 15 illustrates concatenating normal estimates based on the method of FIG. 14A.

FIG. 16A illustrates a method for layout extraction according to an exemplary embodiment.

FIG. 16B illustrates the method for layout extraction of FIG. 16A.

FIG. 17 illustrates detecting seams based on the method of FIG. 16A.

FIG. 18 illustrates detecting seams based on the method of FIG. 16A.

FIG. 19 illustrates detecting seams based on the method of FIG. 16A.

FIG. 20 illustrates a method for layout extraction according to an exemplary embodiment.

FIG. 21 illustrates a layout extraction according to an exemplary embodiment.

FIG. 22 illustrates a method for layout extraction according to an exemplary embodiment.

FIG. 23 illustrates refining initial plane masks based on the method of FIG. 22.

FIG. 24 illustrates refining initial plane masks based on the method of FIG. 22.

FIG. 25 illustrates a method for layout extraction according to an exemplary embodiment.

FIG. 26 illustrates a method for layout extraction according to an exemplary embodiment.

FIG. 27 illustrates a layout extraction according to an exemplary embodiment.

FIG. 28 illustrates an application for a method for layout extraction according to an exemplary embodiment.

FIG. 29 illustrates experimental results for layout extraction according to an exemplary embodiment.

FIG. 30 illustrates experimental results for layout extraction according to an exemplary embodiment.

FIG. 31 illustrates an application for a method for layout extraction according to an exemplary embodiment.

FIG. 32 illustrates experimental results for layout extraction according to an exemplary embodiment.

FIG. 33 illustrates a method for layout extraction according to an exemplary embodiment.

FIG. 34 illustrates a method for layout extraction according to an exemplary embodiment.

FIG. 35 illustrates a method for layout extraction according to an exemplary embodiment.

FIG. 36 illustrates a method for layout extraction according to an exemplary embodiment.

FIG. 37 illustrates the components of the specialized computing environment configured to perform the method for layout extraction according to the exemplary embodiments described herein.

### DETAILED DESCRIPTION

While methods, apparatuses, and computer-readable media are described herein by way of examples and embodiments, those skilled in the art recognize that methods, apparatuses, and computer-readable media for layout extraction are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The present method, apparatus, and computer-readable medium addresses at least the problems discussed above in layout extraction. As discussed above, layout extraction methods can utilize scene capturing technology and piecewise planar reconstruction techniques to model various scenes, e.g., rooms. However, reliance on RGB images exclusively can result in an inaccurate model of a scene.

Existing systems and methods might fail to recognize or utilize modeling tools available from the scene, such as gravity vectors, orientations, and depth information. Further, existing systems and methods might rely on assumptions regarding the layout that inaccurately capture the room geometry. For example, existing systems and methods may assume adjacent walls are connected when the walls are actually disconnected in the scene. In another example, existing systems and methods may assume a ceiling in the scene is rectangular, or that the scene contains only one ceiling. Accordingly, existing systems and methods may place corners or seams between walls and the ceiling at incorrect locations.

Existing systems and methods may be unable to model complex geometries, either partially or wholly ignoring or misinterpreting details in the scene, including doors, windows, curvatures, and various architectural features. Some existing systems and methods may utilize a single image to reconstruct a scene. The single image might not provide full visibility of the scene though, as occlusions, such as furniture and wall-hanging objects, e.g., artwork, can block the background layout. Because of these limitations, existing systems and methods can be unable to model complex geometries that might include details, such as corners, curvatures, walls that do not extend fully from a ceiling to a floor, windows, doors, and architectural features, such as arches, columns, or baseboards.

The present system addresses these problems by utilizing additional contextual, or perceptional, information (e.g. instance segmentation, geometric edge detection, occluded wall connectivity perception) and line segments identified in a scene to produce a more geometrically complete and consistent estimate of the architectural layout of the scene. As described herein, scenes can be more precisely modeled by better defining boundaries of layout planes based on the contextual information and/or line segments. Layout plane masks corresponding to the layout planes can be accurately predicted based on classifying and grouping line segments into planes to achieve precise mask boundaries. The layout planes can be defined with line segments to form the layout plane masks. In addition, fewer or no assumptions are made regarding room corners or seams between adjacent walls, for example, in comparison to existing methods. Instead, confidence values are determined regarding the layout plane masks to optimize the layout plane masks. Using plane connectivity and depth and semantic segmentation priors, the layout plane masks can be optimized, providing a detailed and true model of the scene.

The novel method, apparatus, and computer-readable medium for layout extraction will now be described with reference to the figures.

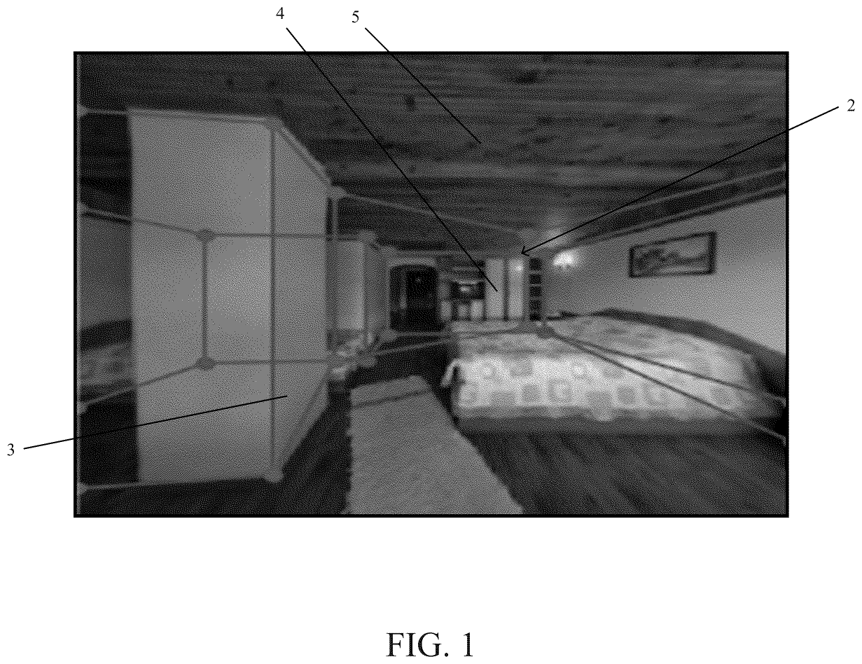

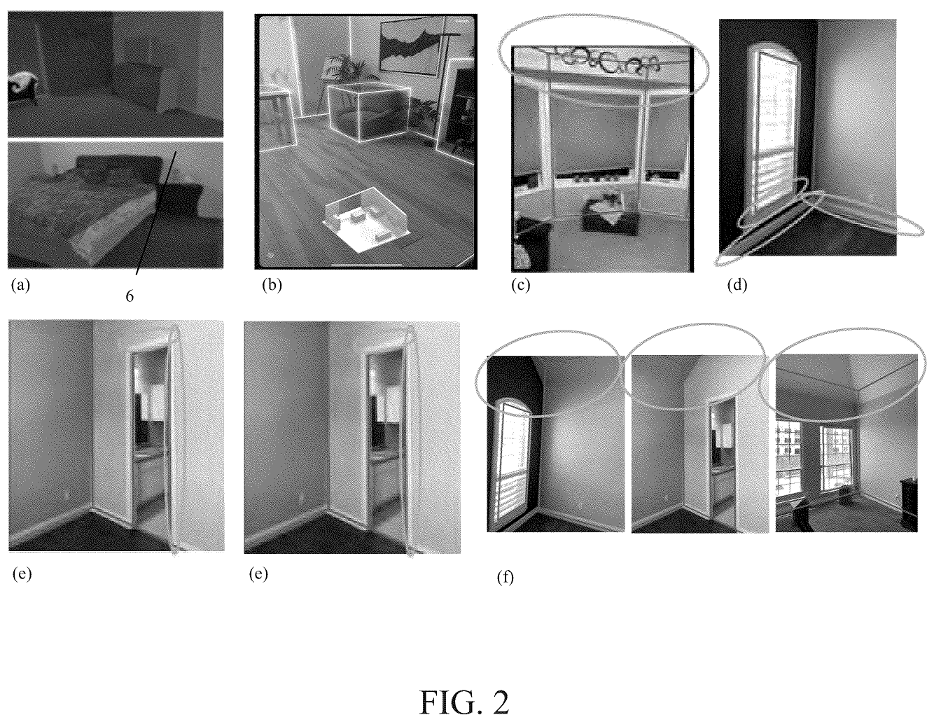

FIGS. 1-2 illustrate existing layout extractions. As shown in FIG. 1, the layout extraction in “red” fails to account for disconnected walls, and instead connects walls that are remote from one another, conflating the room geometry. At 2, for example, the “red” extraction connects a beam column 3 with a background wall 4, which are remote from each other, creating a continuity in the model that does not exist in the scene. In other words, the model assumes beam column wall 3 and background wall 4 are connected when they are actually disconnected in the scene. In addition, the room corners are inaccurately represented and arbitrarily assigned in the model. The imprecision here can be due to the ceiling 6 being non-rectangular, which the existing cannot adequately model. In FIG. 2, (a) shows layout masks from the planar reconstruction method that are coarse and imprecise. Further, the walls are shown as occluded, or blocked from view by room objects, including a dresser, a bed, and a side table. The occluded walls, e.g., wall 6, are inaccurately modeled as the systems and methods do not understand the room planes behind the room objects, distorting the layout masks used for the models. In (b) a model is shown from a video of a room. As with the layout masks in (a), in (b), the layout masks are imprecise in view of the occlusions. In (c)-(f), aspects of complex geometries are omitted in the layout extraction. For example, in (c), a soffit is not detected as a separate wall. Instead, the walls are assumed to span from a single ceiling surface to the floor. In (d), the baseboard and window frame are omitted from the layout extraction. In (e), the door frame is omitted from the layout extraction. And in (f), the ceiling is assumed to be rectangular as having a single surface such that the depicted non-rectangular ceiling with multiple surfaces is not accurately modeled. FIGS. 1-2 exemplify the difficulties in modeling complex room geometries. The results are simplified room models that are imprecise and incompletely capture the room background behind existing objects.

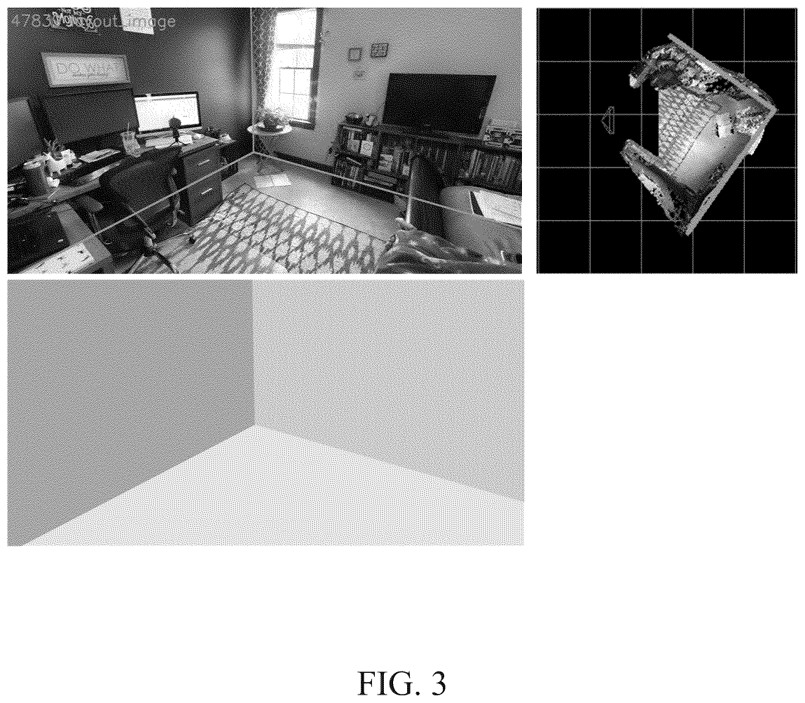

FIG. 3 discloses an exemplary embodiment of a layout extraction system 100 in accordance with this disclosure. Applications of the layout extraction described herein can be to model the key architectural surfaces of a room for interior design, for example. Mixed reality technologies are proving to be promising ways to help users reimagine rooms with new furnishings. However, these technologies need to understand the surfaces to hang objects on the surfaces. The problems addressed by the layout extraction described herein assist users with accurately representing a scene and minimizing modeling interferences derived from occlusions and surface connectivity. The described systems and methods can utilize inputs available to the user on their user device, e.g., smartphone, such that external laser depth sensors are not needed to supplement photography.

Based on one or more inputs, including one or more images of a scene or contextual information, the layout can be extracted, the layout being a geometrically consistent empty version of a scene. The layout can be a 3D representation of one or more surfaces, e.g., walls, floor, ceiling, windows, doors, soffits, etc., and/or 2D representations of the same data (floor plans, elevation plans, etc. A single input or a plurality of inputs can be used to generate the 3D and/or 2D representations of the scene. As shown in FIG. 3, the layout extraction shows more accurate surface modeling, including at seams and corners, and understands complex room geometries such as wall openings, cavities, beams, and multiple ceilings. The layout extraction is also a more accurate in view of foreground objects, including occlusions, such as the furniture in the room, surface features, such as windows and doors, and architectural features, such as arches, columns, or baseboards. In addition, the present system allows users to “erase” imagery of physical furniture or other occlusions, allow users to view a blank layout, while maintaining realistic coherence of geometry, imagery, and shading, that is sufficient to allow reimagining of the space in the interior design context.

The methods described herein can be implemented in a user facing system. A user can take a photo or multiple photos of a space showing a scene (e.g., a room in their house). The user can also take a video of the space, in other examples. The user can utilize any user device having a camera, such as a smartphone, laptop, tablet, or digital camera. Using the techniques described in greater detail below, the layout of the scene can be modeled. Based on one or more inputs, a framework of the layout can be identified and modeled, rendering a more accurate view of the scene background. Once this modeling is complete, a user can apply virtual objects, e.g., furniture or wall-hanging objects, to the scene to simulate various interior design options, and architectural editing and planning, for example. Features of the system can include:
Allowing for capture of input images from a variety of user devices;
Creating a model of the scene from a single image or multiple images;
Creating a model of the scene from one or more layout aspects in the scene, e.g., corners;
Modeling multiple planes, including multiple ceilings, floors, soffits, baseboards, and foreground objects, for example;
Utilizing one or more inputs to create the model of the scene such that the system has flexibility in which inputs are required for scene modeling; and
Recreating complex geometries in a scene with higher fidelity, where the complex geometry may comprise non-rectangular surfaces, corners, curvatures, walls that do not extend fully from a ceiling to a floor, occlusions, windows, and doors, and architectural features, such as arches, columns, or baseboards, and geometries that may include openings or non-Manhattan shapes.

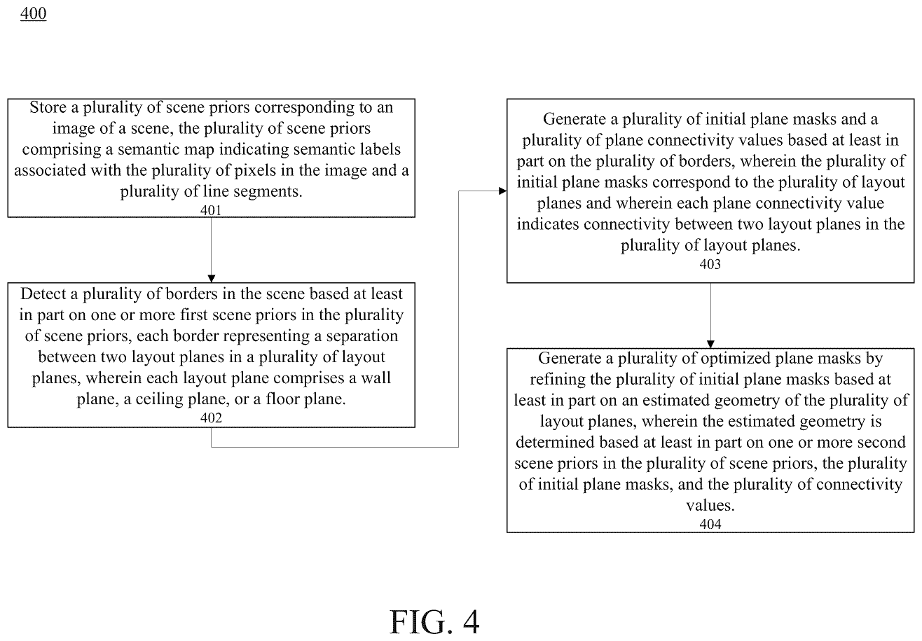

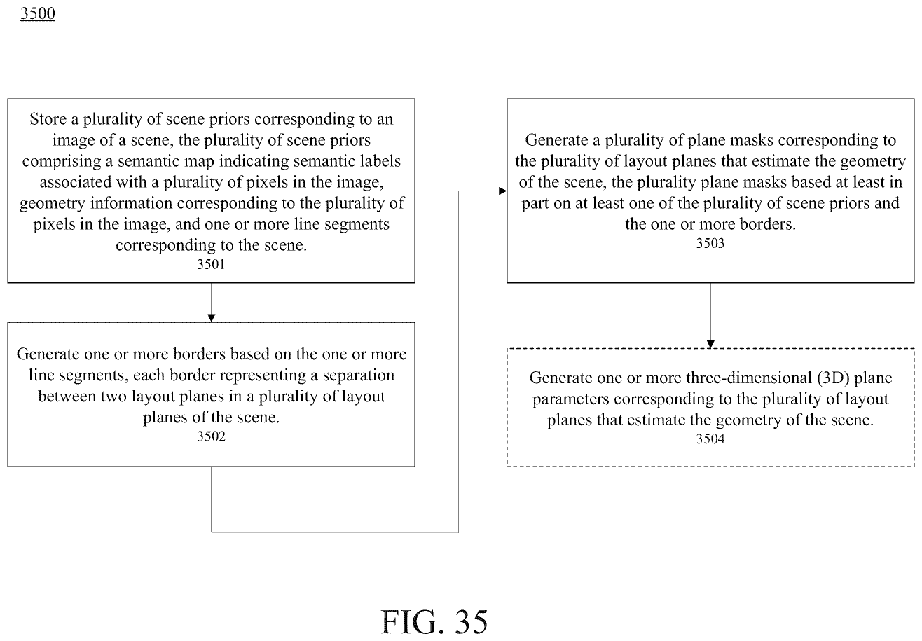

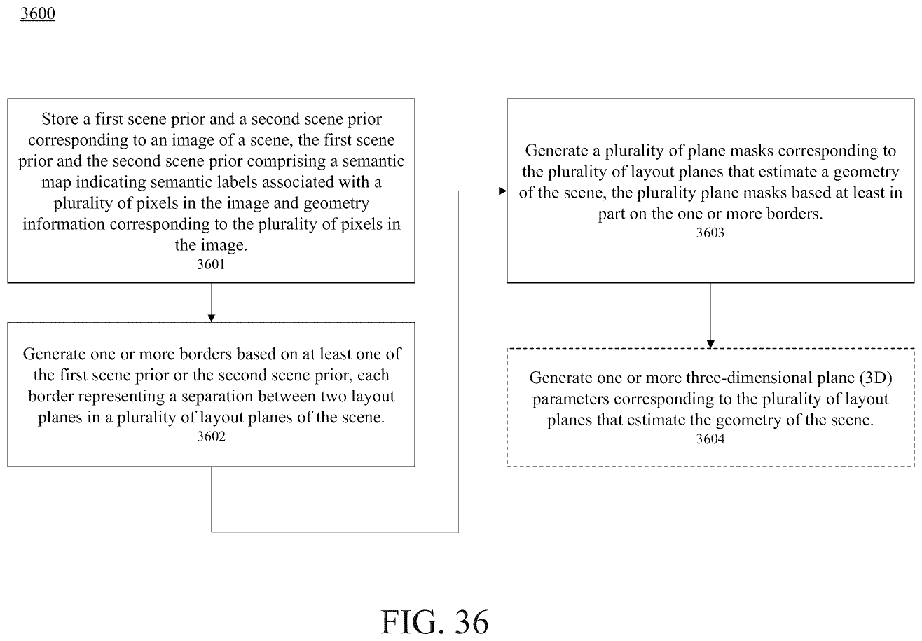

FIG. 4 illustrates a flowchart of a method 400 for layout extraction according to an exemplary embodiment. The method can be performed on a server that interfaces with a client and having sufficient computing resources to perform the graphics, modeling, and machine learning tasks described herein. Alternatively, the method can be performed on a client device having sufficient resources or performed on a computing device or set of computing devices outside of a client-server system. Method 400 can be similar to method 3500 (FIG. 35) and/or method 3600 (FIG. 36), and can include one or more steps from method 3500 and/or method 3600.

Steps of method 400 can generally include one or more of the following:
Using semantic segmentation to aid the detection of layout planes, e.g., wall, floor and ceiling planes;
Considering as walls the pixels with one of the following semantic labels: wall, window, blinds, curtains, door, picture, whiteboard, etc.
Defining layout plane boundaries using lines and edges;
Extracting layout borders that do not correspond to a visible line, due to e.g. occlusions, to generate the layout planes;
Using gravity to detect wall-wall seams, e.g., borders between layout planes; and
Optimizing the layout planes to generate 3D plane estimation.

In this way, method 400 can provide detailed, automatic, parametric computer-aided design modeling.

Prior to the initial step (in methods 400, 3500, and/or 3600), a user can capture and upload one or more images of a scene and/or one or more videos of the scene. The image or images are then processed and analyzed to extract or determine the contextual, or perceptional, information. This can include, for example, 3D points, features, gravity, augmented reality data, etc. The one or more images can be inputs along with optional poses, 3D points, features, gravity information, inertial measurement unit (IMU) data streams, and/or augmented reality data. As part of this step, the input preprocessor 502 can obtain one or more images, gravity, camera poses, 3D points or depth maps, features, and/or AR data. The images can be RGBD (Red-Green-Blue-Depth) images, RGB images, gray-scale images, RGB images with associated IMU data streams, and/or RGBD images of a room/space with optional measurement of gravity vector. Of course, any representation of the captured scene (e.g. point clouds, depth-maps, meshes, voxels, where 3D points are assigned their respective texture/color) can be used. The inputs can be further processed to extract layout information, as described in greater detail below.

At step 401, a plurality of scene priors corresponding to an image of a scene can be stored, the plurality of scene priors comprising a semantic map indicating semantic labels associated with the plurality of pixels in the image and a plurality of line segments. Any of the scene priors, including the plurality of line segments, can themselves be generated from other inputs. The semantic labels can include at least one of a wall, a ceiling, or a floor, for example, or a window or a door.

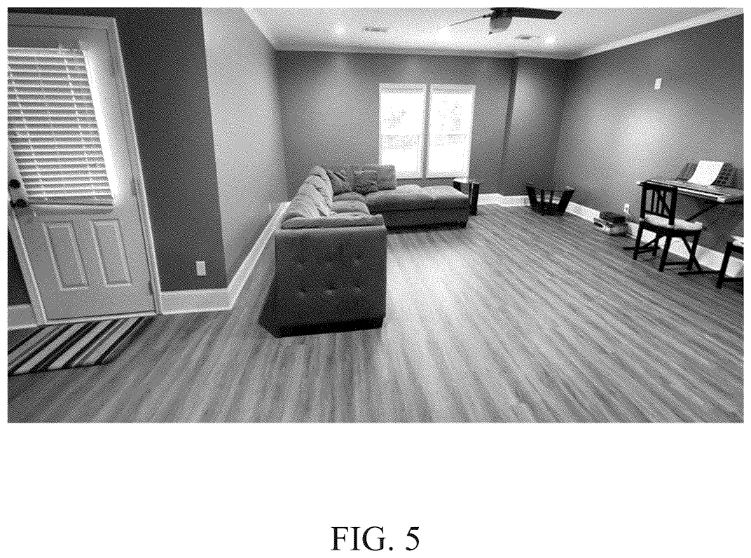

With reference to FIG. 5, one or more images of the scene can be stored. The one or more images can be provided by a user or a refined or otherwise modified version of the one or more images. The one or more images can be input images, and scene priors. One or more video captures of the scene can similarly be input videos, and scene priors. A plurality of images can represent various poses of the scene such that the scene can be captured from multiple vantage points. In this way, aspects of the scene, e.g., surfaces or corners of the layout and foreground objects, can be viewed from multiple angles, including side views.

The additional data derived from additional viewpoints and images also allows for improvements in layout extraction. Viewing aspects of the scene from multiple angles can elevate the scene modeling by facilitating visibility. For example, viewing nested objects, or objects adjacent one another in various arrangements, from several angles can provide additional pixels such that removing some occlusions does not automatically eliminate visibility of the background layout. Instead, the additional pixels can act as replacement pixels to create visibility of the background behind some occlusions. Multiple views and images also allow for building better three dimensional views of objects and provide additional views of geometry and textures from various architectural features.

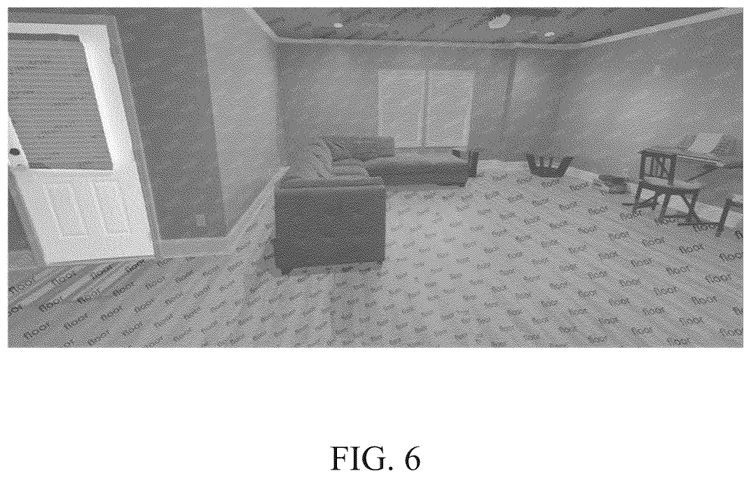

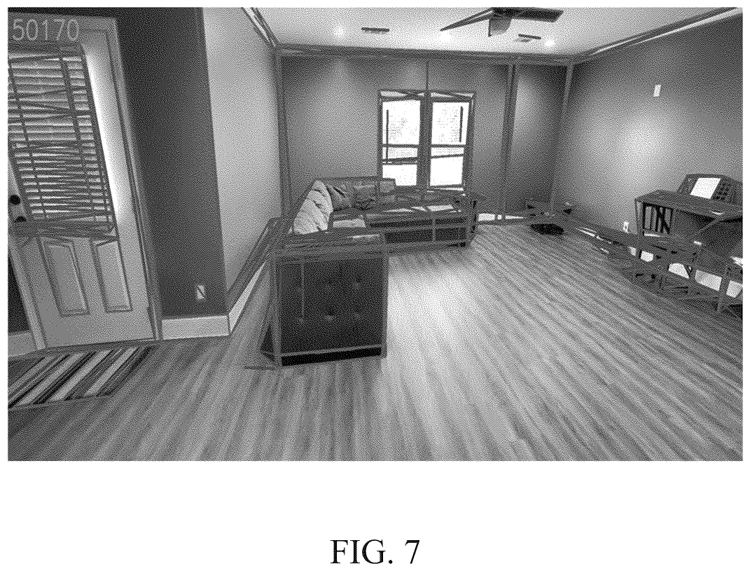

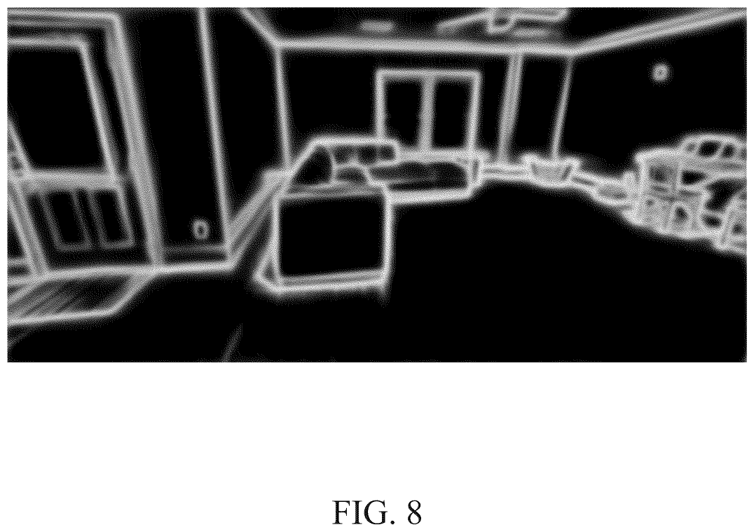

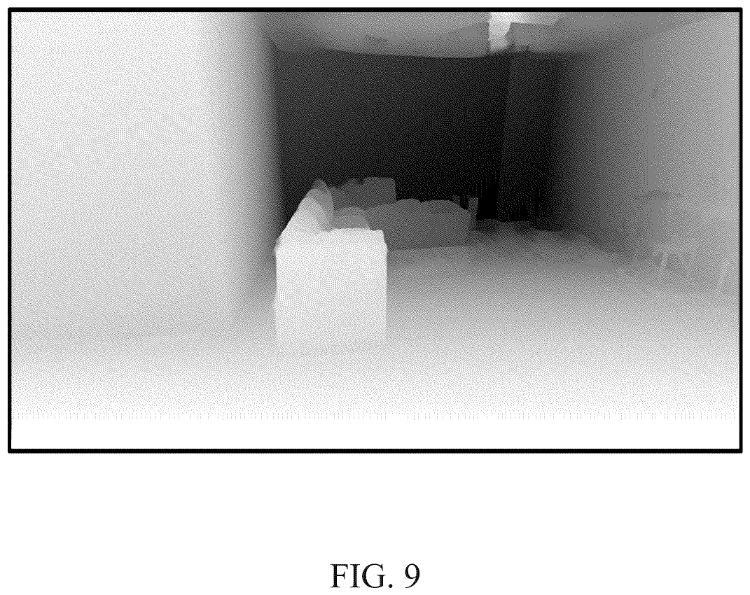

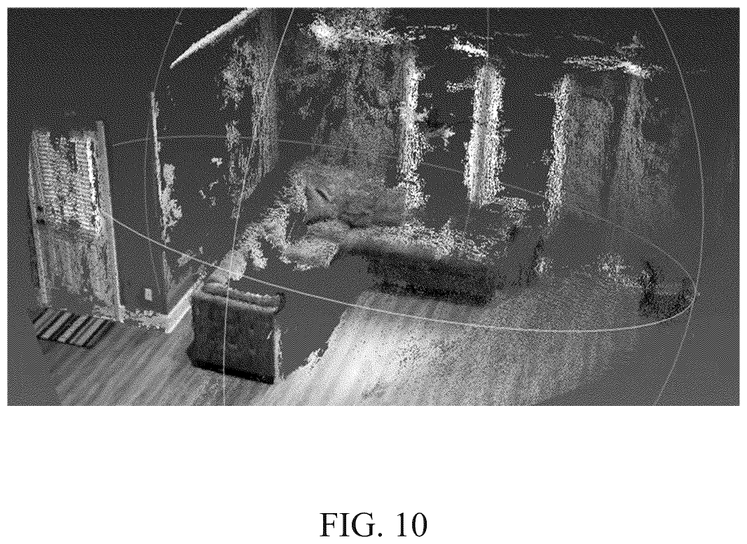

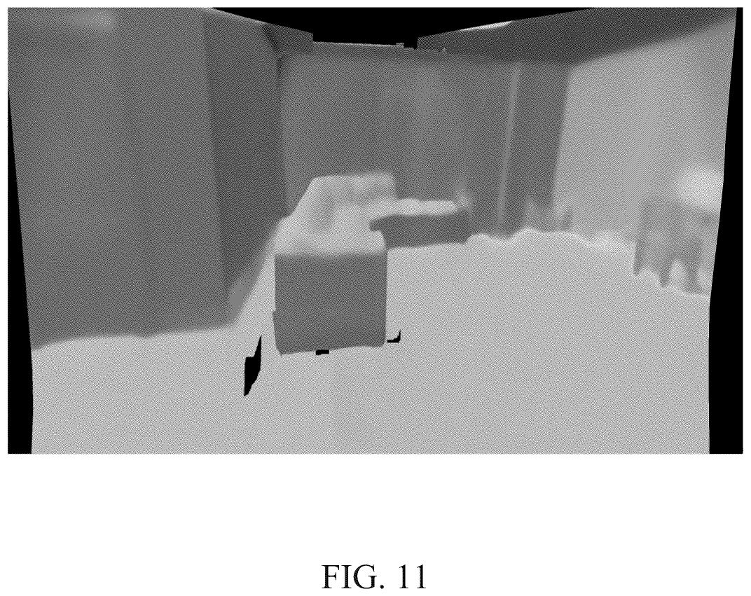

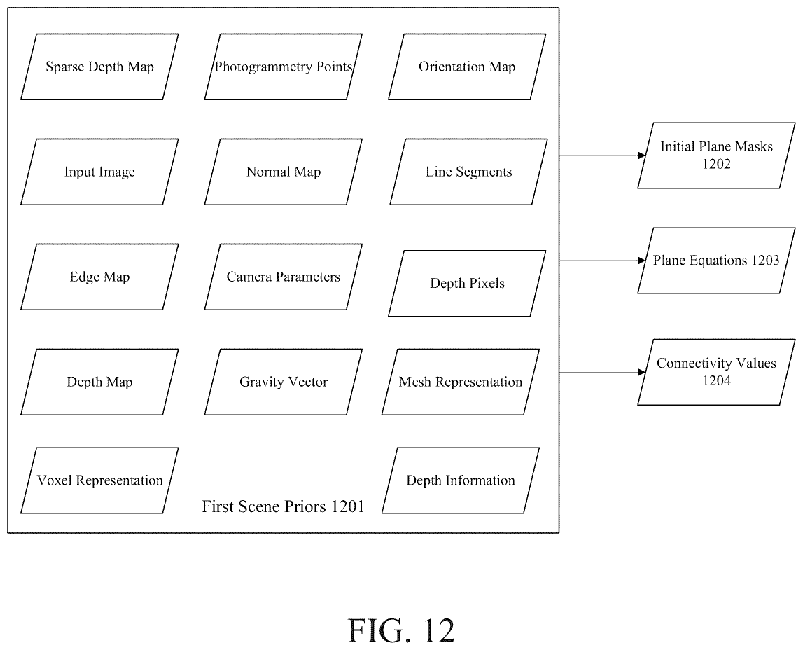

Scene priors based on the one or more of input images can include a semantic map (FIG. 6), line segments (FIG. 7), edge maps (FIG. 8), depth maps (e.g., dense depth maps) (FIG. 9), photogrammetry points (e.g., sparse points) (FIG. 10), and/or normal maps (FIG. 11). Additional scene priors, such as orientation maps, camera parameters, LiDAR sensors, and/or gravity vectors (FIG. 12), can be stored. The depth map, photogrammetry points, sparse depth map, depth pixels storing both color information and depth information, mesh representation, voxel representation, depth information associated with one or more polygons, and/or orientation map corresponding to the plurality of pixels can comprise geometry information (e.g., analyzing coordinates in three dimensional) of the scene.

The scene priors can be extracted from one or more images and can be contextual, or perceptional, information corresponding to a plurality of pixels in the one or more images. The contextual, or perceptional, information can include perceptual quantities, aligned to one or more of the input images, individually or stitched into composite images. The depth maps, for example, can be obtained by using dense fusion on RGBD (e.g., an RGB image taken on a camera with depth inputs), or by densifying sparse reconstruction from RGB images (such as through neural network depth estimation and multi-view stereoscopy). Metric scale can be estimated using many methods including multi-lens stereo baseline, active depth sensor, visual-inertial odometry, SLAM (Simultaneous Localization and Mapping) points, known object detection, learned depth or scale estimation, manual input, or other methods. In this step a set of one or more images, with (optionally) information about gravity, poses, and depths can be used to extract various perceptual information like semantic segmentation, edges, and others, using task-specific classical/deep-learning algorithms. The contextual, or perceptional, information can be aligned to one or more of the input images, or to a composed input image e.g. a stitched panorama.

Various scene priors will now be described with reference to FIGS. 5-12.

FIG. 6 shows a semantic map corresponding to a scene, which can be a scene prior. The semantic map of the scene can be formed by semantic segmentation of the scene. As shown, the pixels in the scene can be semantically segmented such each pixel in a plurality of pixels in the image is associated with a semantic label. For example, pixels that form part of a window in the scene can be labeled window, pixels that form part of a wall can be labeled wall, and pixels that form part of the floor can be labeled floor. As shown in FIG. 6, the pixels that form part of walls, windows, floors, and/or ceilings are semantically labeled. Although not shown in this figure, semantic labels can be used for other aspects of a scene. Semantic labels can include labels corresponding to floors, walls, tables, windows, curtains, ceilings, chairs, sofas, furniture, light fixtures, lamps, and/or other categories of foreground objects. Semantic labels can also include labels corresponding to seams, corners, connectivity, and/or architectural features, such as arches, columns, or baseboards.

The semantic map can include three-dimensional semantic maps, in which semantic labels (such as those described above), are associated with three dimensional geometry, such as polygons or voxels. In this case, the semantic map still includes semantic labels associated with a plurality of pixels, when the scene is viewed as an image from the vantage point of a camera, but the semantic map structure itself maps semantic labels to three dimensional structures.

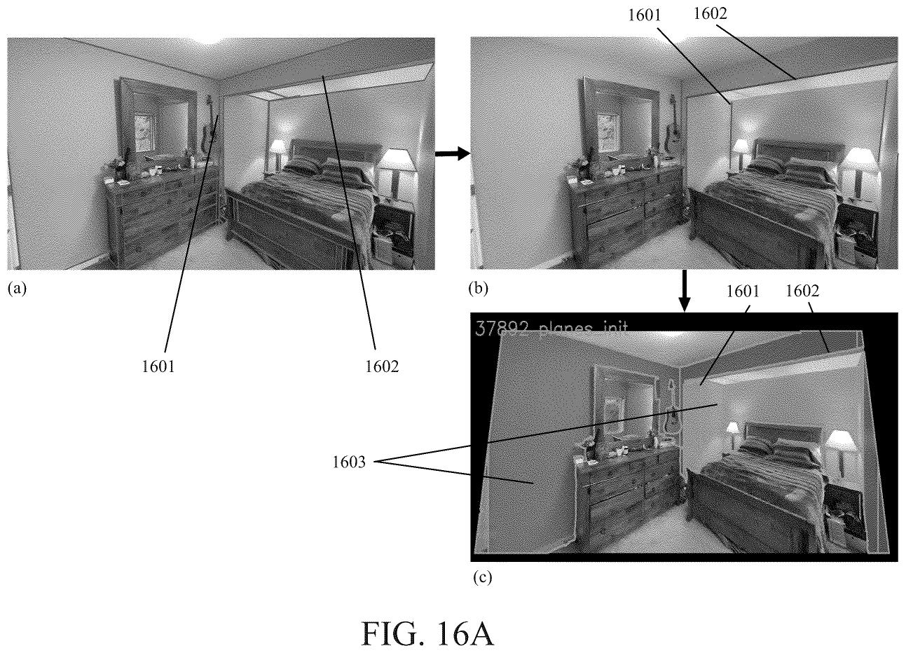

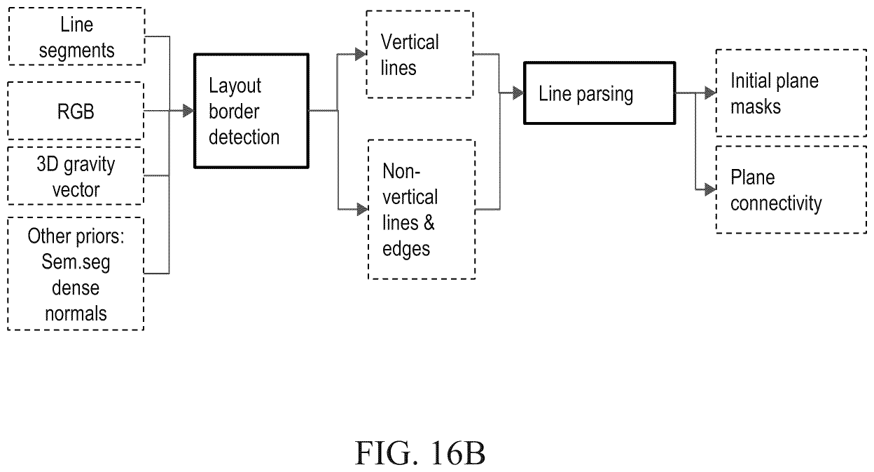

FIG. 7 shows line segments corresponding to a scene, which can be a scene prior. The line segments can be generated based at least in part on one or more of an input image, a normal map, an edge map, and a semantic map. The line segments in the scene can represent borders between layout planes, e.g., planes corresponding to surfaces, such as walls, ceilings, and floors. Layout planes can additionally or alternatively correspond to openings, e.g., areas between walls that do not span from a floor to a ceiling. The line segments can also represent edges of layout planes and connectivity, e.g., whether borders of layout planes are connected or disconnected with borders of other layout planes. The line segments can be used to extract an initial estimate of layout plane masks corresponding to the layout planes of the scene, where the layout planes can be planar or curved. The initial estimate can later be optimized to account for object occlusions, for example. The line segments will be described in greater detail below, such as with respect to FIGS. 16A-B.

FIG. 8 shows an edge map corresponding to a scene, which can be a scene prior. The edge map can correspond to a plurality of edges in the scene. The edges can be detected from an input image, such as the image shown in FIG. 5. Some edges can be wall-wall seams, e.g., edges that form boundaries between adjacent walls. Other edges are not seams but may have important perceptual meaning. For example, the edges can be a depth edge discontinuity between a proximate foreground plane and a more distant background plane or can indicate sharp linear color changes, etc.

FIG. 9 shows a depth map corresponding to a scene to provide depth information (e.g., identifying objects at the front of an image relative to a background or background planes/geometry), which can be a scene prior. The depth map can correspond to a plurality of pixels in an image of the scene, such as the image shown in FIG. 6. In a depth map, each pixel in a plurality of pixels of the scene can be mapped to a particular depth value. Other types of depth maps can be utilized, including a sparse depth map corresponding to the plurality of pixels, a plurality of depth pixels storing both color information and depth information, a mesh representation corresponding to the plurality of pixels, a voxel representation corresponding to the plurality of pixels, or depth information associated with one or more polygons corresponding to the plurality of pixels.

For example, the system can store a three dimensional geometric model corresponding to the scene or a portion of the scene. The three dimensional geometric model can store x, y, and z coordinates for various structures in the scene. These coordinates can correspond to depth information, since the coordinates can be used with camera parameters to determine a depth associated with pixels in an image viewed from the camera orientation.

FIG. 10 shows photogrammetry points corresponding to a scene, which can be a scene prior. The photogrammetry points can derive coordinates, or other forms of measurements, from an input image, such as the image shown in FIG. 5, to model the scene. Photogrammetry points can be represented by a set of 3-dimensional (X,Y,Z) point values, where each point can be optionally associated with pixels from one or more images (e.g., a “point cloud”). Alternatively, 3D photogrammetry points can be represented by their 2D RGBD projection onto a depth map image from a given camera position, or any other representation that retains the 3D positional data of the points.

FIG. 11 shows a normal map corresponding to a scene, which can be a scene prior. The normal map can correspond to a plurality of normals in the scene. The normal map can be determined from the pixels in the scene, such as from the semantic map of the scene shown in FIG. 6. The normal map can have a normal value for each pixel in the image. In this way, the normal map can estimate the surface normal orientation of the surface indicated by each pixel,

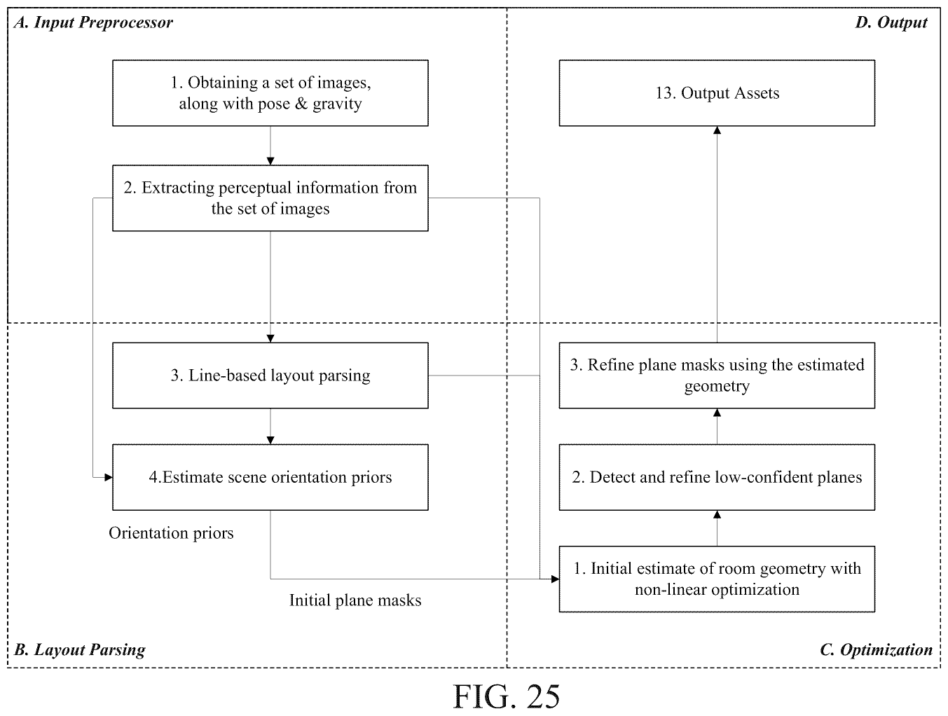

Scene priors can be inputs to generate one or more outputs. FIG. 12 shows first scene priors 1201, according to an exemplary embodiment. First scene priors can include one or more of the plurality of scene priors discussed above with reference to FIGS. 5-11. First scene priors 1201 can be used to generate outputs, e.g., initial plane masks 1202 having plane equations 1203 and connectivity values 1204. First scene priors 1201 can additionally or alternatively include orientation maps, camera parameters, and/or gravity vectors. An input preprocessor (e.g., as shown in FIG. 25) can receive one or more scene priors, such as first scene priors 1201, to generate outputs, where the outputs are inputs that are passed through and/or modified by the input preprocessor. The input preprocessor can be implemented as a set of software functions and routines, with hardware processors and GPUs (graphics processing units), or a combination of the two.

Camera parameters can include intrinsic parameters, such as focal length, radial distortion and settings such as exposure, color balance, etc., and also extrinsic parameters. Camera parameters can be scene priors to generate the layout extraction.

Gravity vectors can be estimated from an IMU, from a VIO or SLAM system, from camera level/horizon indicator, from vanishing point and horizon analysis, from neural networks, etc.

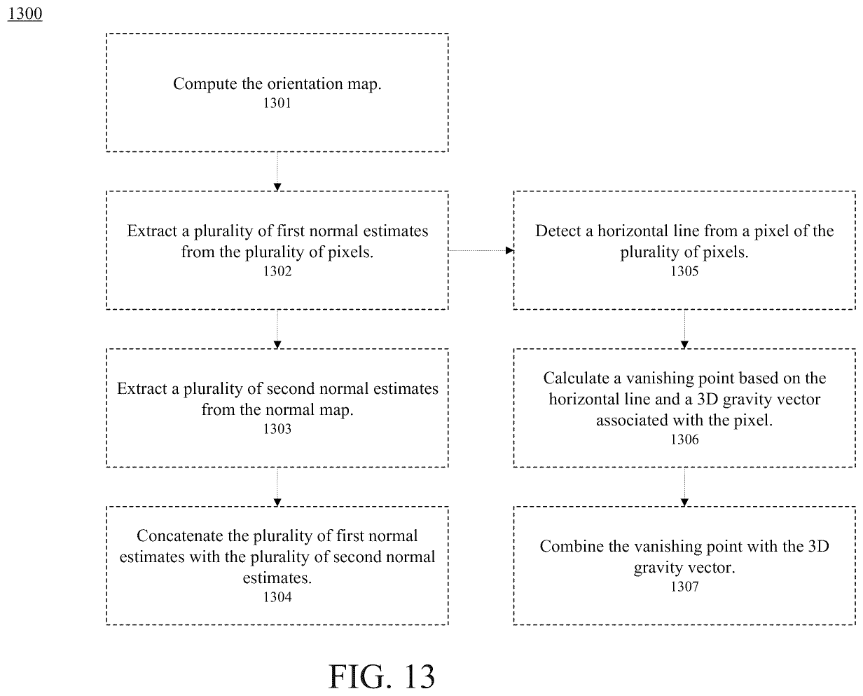

Determining an orientation map can include a method 1300 shown in FIG. 13, according to an exemplary embodiment. As discussed above, the orientation map can be a first scene prior 1201 (FIG. 12). The orientation map can assign a set of possible orientations per image pixel. In other words, for a single pixel in an image, multiple possible estimates for orientation can be obtained. For a given pixel, an orientation is the direction of the wall plane at that pixel, and can be a 3D normal vector n=[nx, ny, nz], or any other representation of rotation (Euler angles etc.). The orientation map can be determined as part of a layout parsing step (e.g., as shown in FIG. 25) as various algorithmic steps can be required to generate orientations. At step 1301, the orientation map can be computed, e.g., orientation priors can be estimated. The estimates can then be optimized. Computing the orientation map can include concatenating normal estimates from a deep network and pixels, e.g., via steps 1302-1305.

At step 1302, a plurality of first normal estimates from the plurality of pixels can be extracted. First normal estimates can be derived from background horizontal lines in the plurality of pixels. Accordingly, first normal estimates can be line-based normal estimates. As shown, step 1302 can include steps 1305-1307. At step 1305, a horizontal line from a pixel of the plurality of pixels can be detected. The detection of horizontal lines can be completed using a deep network. Lines, such as borders, can be selected, with outliers being rejected. Outliers can be identified by calculating the agreement of a vanishing point of a particular line against vanishing points of other lines in the scene. At step 1306, a vanishing point based on the horizontal line and a 3D gravity vector associated with the pixel can be calculated. At step 1307, the vanishing point can be combined with the 3D gravity vector. In this way, a 3D normal for a vertical plane is determined.

At step 1303, a plurality of second normal estimates from the normal map can be extracted. The second normal estimates can be from a deep network.

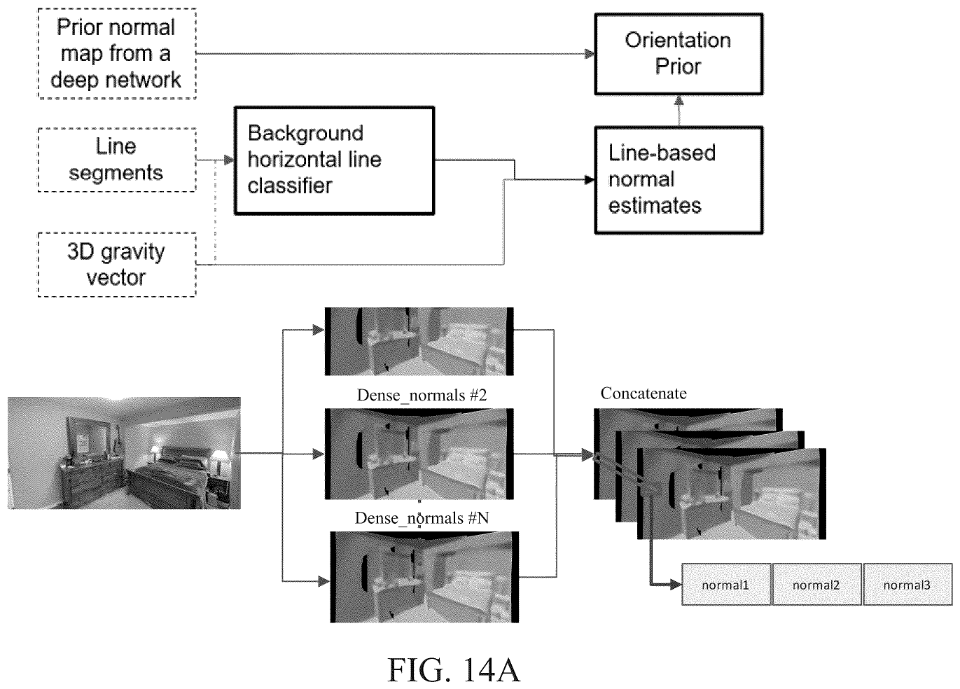

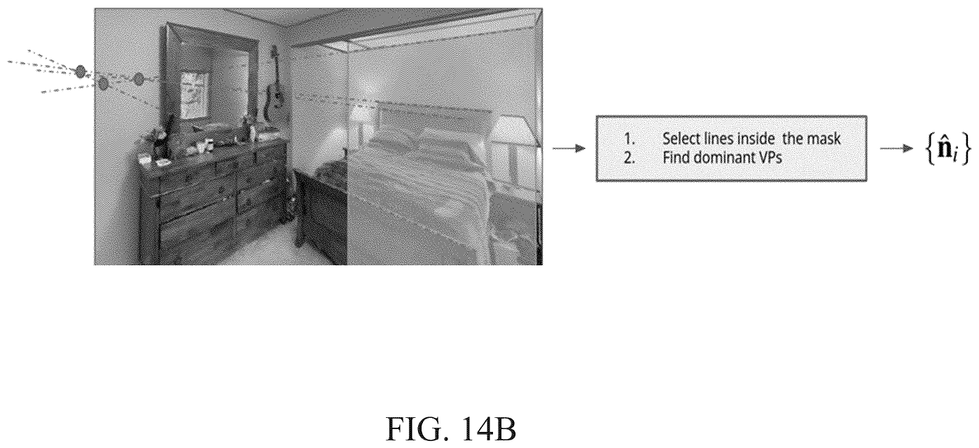

At step 1304, the plurality of first normal estimates with the plurality of second normal estimates can be concatenated. Step 1304 can be illustrated with FIG. 14A, according to an exemplary embodiment. As shown, the plurality of first normal estimates can be first dense normals. The plurality of second normal estimates can be second dense normals. N estimates for the normals of each pixel in the input image can result from concatenating the first dense normals and the second dense normals, yielding the orientation map.

FIG. 14B shows the method of FIG. 14A, according to an exemplary embodiment. As shown the orientation prior can be build from lines using one or more of the following steps:
For each plane mask, accumulate all visible lines;
Classify each visible line as horizontal or not;
Determine that each line, if horizontal, votes for a vanishing point, and, consequently, a normal vector for the plane.
Accumulate normal vectors and append to the orientation prior list.

In this way, using gravity and the information of lines being horizontal inside the input mask area, a candidate normal vector for the plane can be created.

Referring back to FIG. 4, at step 402, a plurality of borders in the scene based at least in part on one or more first scene priors in the plurality of scene priors can be detected. Each border can represent a separation between two layout planes in a plurality of layout planes. Step 402 can be a line-based layout parsing step (e.g., as shown in FIG. 25) to define layout masks.

Each layout plane corresponds to a background plane, such as wall/window/door plane, a floor plane, and/or a ceiling plane. For example, each layout plane can be a wall plane corresponding to a wall, a ceiling plane corresponding to a ceiling, or a floor plane corresponding to a floor, for example. Layout planes can be planar or curved. Each of the layout planes can be stored as a segmentation mask for the image(s), the segmentation mask indicating which pixels in the image(s) correspond to a particular plane. 3D plane equations can also be computed for each of the layout planes, with the 3D plane equations defining the orientation of the plane in three-dimensional space. To track this information on a per-plane basis, planes can have corresponding plane identifiers (e.g., wall 1, wall 2, ceiling, etc.) and the plane identifiers can be associated with plane equations for each plane. The layout map can also include structures other than walls, ceilings, and floors, including architectural features of a room such soffits, arches, pony walls, built-in cabinetry, etc.

Borders between layout planes can be based on first scene priors 1201 in FIG. 12 to form initial plane masks 1202 corresponding to the layout planes. In other words, borders between wall planes, ceiling planes, and floor planes can be detected to form wall layout plane masks, ceiling layout plane masks, and floor layout plane masks.

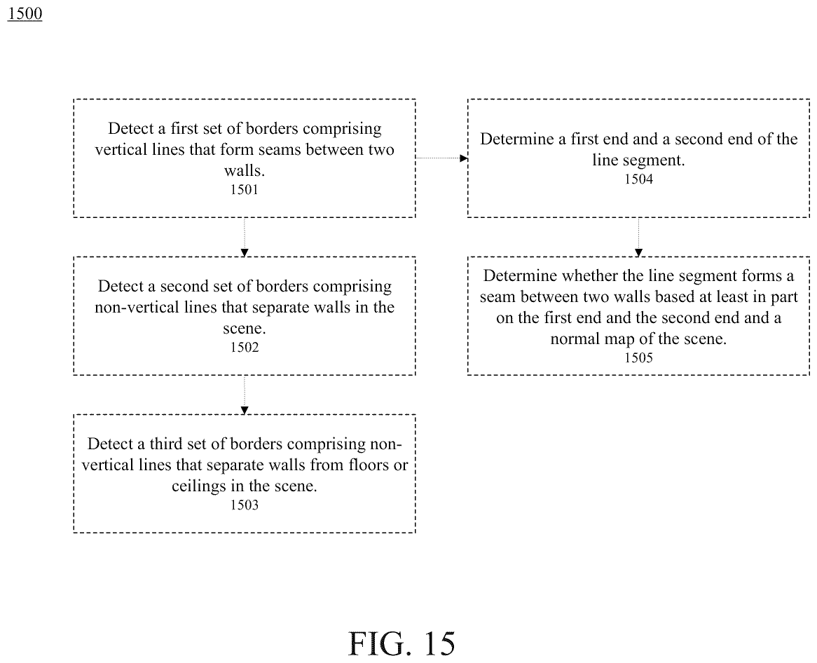

FIG. 15 illustrates a flowchart of a method 1500 for detecting borders according to an exemplary embodiment.

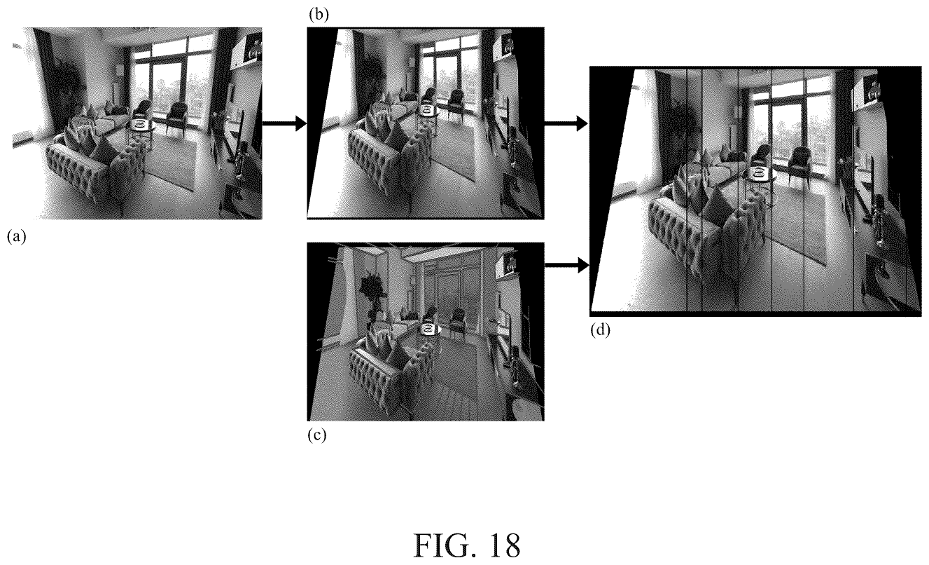

At step 1501, a first set of borders comprising lines that form seams between two walls can be detected. The lines can represent seams between adjacent, touching wall planes, e.g., wall-wall vertical seams or edges. Line segments, a deep network, and/or other scene priors, e.g., input images and semantic segmentation, can be inputs to detect borders, as shown with reference to FIG. 16A in (a). Step 1501 in FIG. 15 can include steps 1504-1505. At step 1504, a first end and a second end of the line segment can be detected. At step 1505, it can be determined whether the line segment forms a seam between two walls based at least in part on the first end and the second end and a normal map of the scene. The lines detected can be vertical lines 1601 shown in FIG. 16A, for example. Vertical and non-vertical orientation is relative to the three-dimensional model and is discussed further with respect to FIG. 18 below.

At step 1502 in FIG. 15, a second set of borders that separate walls in the scene can be detected. The borders can be non-vertical lines that can represent edges and lines between adjacent wall planes. The lines detected can be non-vertical lines 1602 shown in FIG. 16A in (a) and (b), for example.

At step 1503 in FIG. 15, a third set of borders comprising lines that separate walls from floors or ceilings in the scene can be detected. The borders can be non-vertical lines that can represent edges and lines between wall planes and adjacent floor or ceiling planes. The non-vertical lines detected can be non-vertical lines 1602 shown in FIG. 16A in (a) and (b), for example.

FIG. 16B shows the method of FIG. 16A. As shown, using line segments, in part or exclusively, vertical and/or non-vertical lines can be detected. The line parsing can be to detect borders that define the initial plane masks. The borders can also indicate plane connectivity, e.g., whether two layout planes in the plurality of layout planes are connected or disconnected.

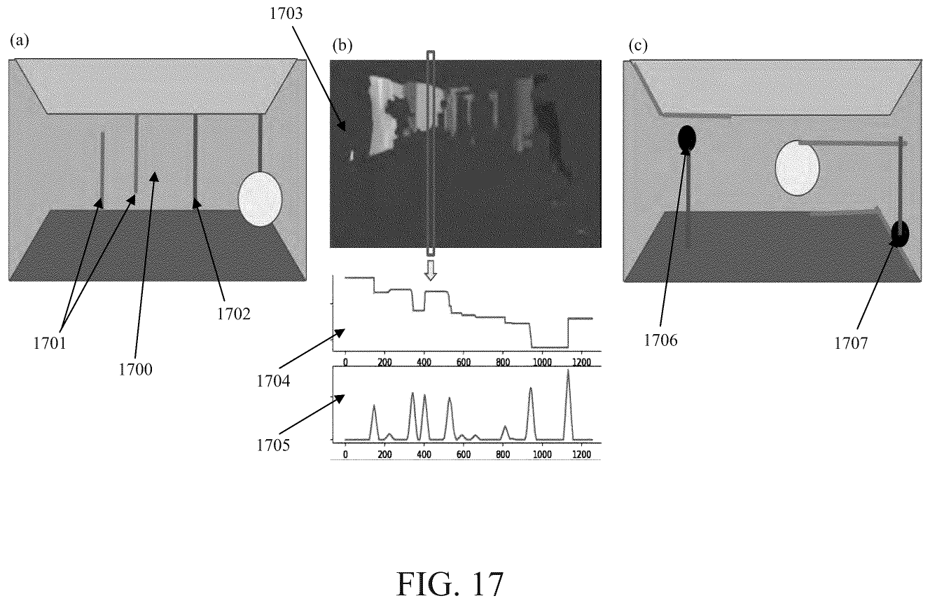

Wall-wall seam, or border, detection can be refined with reference to FIG. 17, according to an exemplary embodiment. Input images and other scene priors can be rectified to be vertical, as discussed further with reference to FIG. 18 below. A wall-wall seam can be identified based on a line spanning a potential plane mask. As shown in FIG. 17 in (a), lines 1701 do not span the potential plane mask 1700 from top-to-bottom and, therefore, are rejected as being wall-wall-seams. Line 1702 does span the potential plane mask 1700 from top-to-bottom and, therefore, is accepted as being a wall-wall-seam. In (b), an input normal map 1703 can have dimensions (H, W, 3) and can be converted to a more compact 1D normal representation 1704 having dimensions (H, W, 1), if it is assumed that walls are vertical in 3D. To convert to 1D normal representation 1704, normals from input normal map 1703 can be converted to spherical coordinates (theta, phi), with only theta being retained. Input normal map 1703 can be reduced to (W, 1), or 1D normal representation 1704, by applying column-wise averaging. Only the normals at the pixels at wall planes can be considered. Pixels at remaining locations can be left as undefined. The location of significant gradients on 1D normal representation 1704 can retained in a normal gradient map 1705, indicating wall seams. As shown in (c) junctions of lines can indicate which wall seams are wall-wall seams. The junctions can be at, for example, 1706 between wall and ceiling planes, or 1707 between wall and floor planes. Seams between these junctions indicate wall-wall seams, and therefore, borders between planes and the boundaries of plane masks. Each of (a), (b), and (c) separately can indicate wall-wall seams. These processes can be run concurrently or successively to independently indicate wall-wall seams.

FIG. 18 shows vertical line rectifying that can be used in the methods of FIGS. 15-17, according to an exemplary embodiment. With reference to (a), an input image, and scene priors thereof, of a scene can be obtained. The input image can be in 2D. As shown in (b), the input image, and scene priors thereof, can be rectified to be vertical. In other words, the input image can be rectified, or transposed, to a fronto-parallel plane using homography mapping. As shown in (c), semantic segmentation and other scene priors can be used to detect line segments. The vertical lines can then be parsed in the rectified 2D image. As shown in (d), wall-wall seams can be detected and refined to determine borders between planes and the boundaries of plane masks. Additionally or alternatively, the vertical lines, e.g., in (a), can be aligned with gravity, e.g., the gravity vector scene priors, in a 3D input image to be rectified as in (b).

Referring back to FIG. 4, at step 403, a plurality of initial plane masks and a plurality of plane connectivity values based at least in part on the plurality of borders can be generated. The plurality of initial plane masks can correspond to the plurality of layout planes and can include at least a partial room-layout estimation having plane equations, non-planar geometry, and other architectural layout information. Each plane connectivity value can indicate connectivity between two layout planes in the plurality of layout planes.

In an example, as shown in FIG. 16A in (c), initial plane masks 1603 can be generated based on vertical lines 1601 and non-vertical lines 1602 that are determined to be borders between planes based on the methods of FIGS. 15-17. Accordingly, one or more first scene priors 1201, shown in FIG. 12, including vertical lines 1601 and non-vertical lines 1602 (FIG. 16A) can be used to generate initial plane masks 1202 having plane equations 1203 and connectivity values 1204.

A plurality of plane equations corresponding to the plurality of planes, a plurality of initial plane masks corresponding to the plurality of planes, and a plurality of connectivity values can be stored, each plane mask indicating the presence or absence of a particular plane at a plurality of pixel locations. The determination of the plane equations and the generation of the plane masks are described with respect to the previous steps. The plane masks can then be used to determine 3D plane equations corresponding to the planes. The plane equations can correspond to 3D plane parameters corresponding to the plurality of layout planes that estimate the geometry of the scene. In other words, the 3D plane equations can define the orientation of the planes in 3D space. These computed values are then stored to be used when determining estimated geometry of the scene.

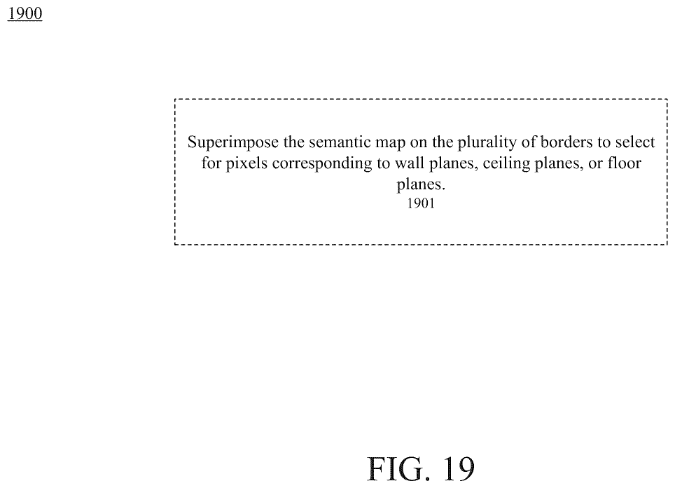

In another example, FIG. 19 illustrates a flowchart of a method 1900 for generating a plurality of initial plane masks and a plurality of plane connectivity values based at least in part on the plurality of borders, according to an exemplary embodiment. This step can be part of a layout parsing step (e.g., as shown in FIG. 25).

The semantic map can be generated by one or more input images for example. At step 1901 the semantic map can be superimposed on the plurality of borders to select for pixels corresponding to wall planes, ceiling planes, or floor planes. These planes can be used to generate the corresponding initial plane masks having plane equations.

Step 1901 can include looking up a semantic labels corresponding to the plurality of pixels in the semantic map to determine what labels are assigned to the pixels. The semantic map can be superimposed on the borders to identify which semantic label corresponds to each of the pixels. This can include, for example, identifying pixels that have a semantic label of wall, ceiling, or floor.

A user can select the pixels corresponding to the planes for modeling. For example, it can be determined which plane is at that pixel location that is selected. Once the planes are identified, the 3D plane equations can be used in conjunction with the locations of pixels corresponding to the planes to determine the estimated geometry of the planes.

Step 1901 can additionally or alternatively include superimposing the semantic map onto the depth map discussed above to determine locations of planes within the scene. As discussed above, the plane masks can then be used to determine 3D plane equations corresponding to the planes. The 3D plane equations can define the orientation of the planes in 3D space.

Referring back to FIG. 4, at step 404, a plurality of optimized plane masks can be generated by refining the plurality of initial plane masks based at least in part on an estimated geometry of the plurality of layout planes, wherein the estimated geometry is determined based at least in part on one or more second scene priors in the plurality of scene priors, the plurality of initial plane masks having plane equations, and the plurality of connectivity values. This step can be part of an optimizing step (e.g., as shown in FIG. 25). As further discussed below, an optimization framework can be used, combining vanishing points (from, e.g., orientation map), wall-wall connectivity constraints, and photogrammetry points to accurately estimate optimized layout mask in non-Manhattan.

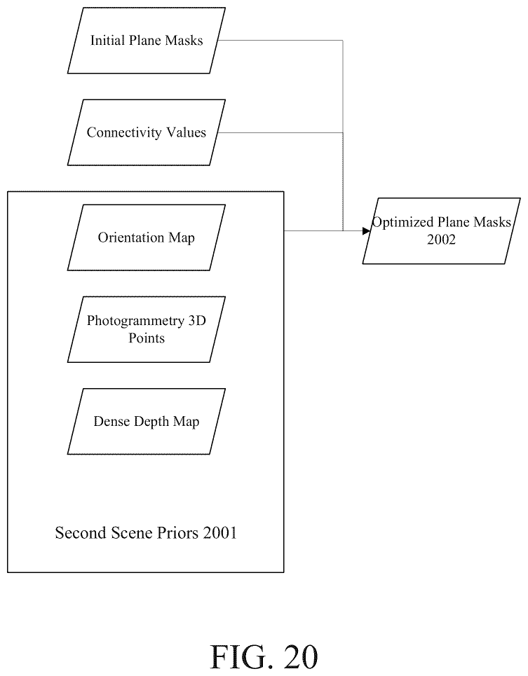

Second scene priors 2001 can be seen in FIG. 20, according to an exemplary embodiment. Second scene priors 2001 can include one or more of the plurality of scene priors, such as one or more of first scene priors 1201 (FIG. 12). As shown, second scene priors 2001 can include one or more of the orientation map, photogrammetry points, and the depth map. Second scene priors 2001, the initial plane masks having plane equations, and the connectivity values can generate optimized plane masks 2002. The connectivity vales, as discussed can indicate whether two layout planes are connected or disconnected. If two layout planes are disconnected, the layout planes may not span from a floor to a ceiling, for example, or an opening may be intermediate to the two layout planes in some other way.

The estimated geometry can include estimated geometry that is curved or curvilinear. The system can include functionality for identifying curved geometry (such as curved walls, arched ceilings, or other structures) and determining an estimate of the curvature, such as through an estimation of equations that describe the geometry or a modeling of the geometry based on continuity.

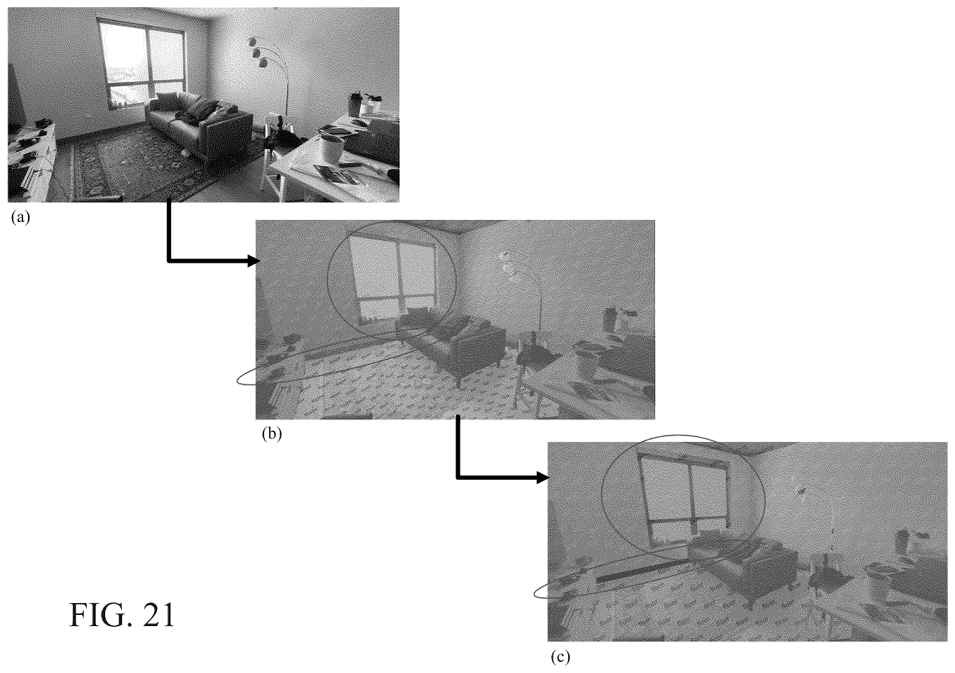

An example of planar optimization is shown in FIG. 21, according to an exemplary embodiment. This step can be part of an optimizing step (e.g., as shown in FIG. 25). As shown, an input image of a scene in (a) can be used to generate initial plane masks having plane equations and connectivity values in (b). Optimized plane masks, shown in (c), can provide detailed layouts that account for window frames and baseboards, for example. Planar optimization can utilize one or more input images, as discussed above. Planar optimization can include applying a non-linear optimization function to refine the initial plane masks and generate the optimized plane masks. The non-linear optimization function can be based on one or more of the plurality of scene priors discussed above.

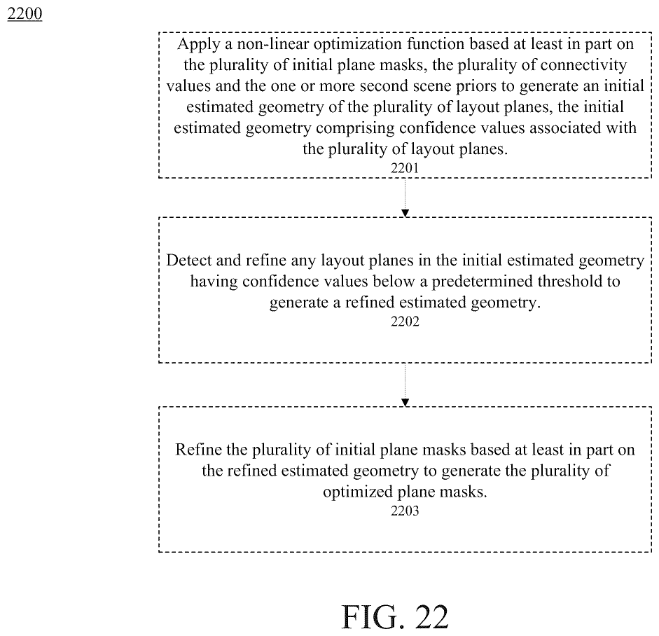

FIG. 22 illustrates a flowchart of a method 2200 for generating a plurality of optimized plane masks according to an exemplary embodiment. Optimization can be processed by one or more of the following steps:
Using non-linear optimization, the plane equations are optimized to obtain an initial estimate, which is robust to outliers;
Identifying the planes in the scene that might have incurred a poor estimate;
Refining the planes having a poor estimate by exhaustively trying the most likely solutions; and
Using the estimated geometry, refining the plane masks to get a consistent scene reconstruction.

At step 2201, a non-linear optimization function can be applied based at least in part on the plurality of initial plane masks, the plurality of connectivity values and the one or more second scene priors to generate an initial estimated geometry of the plurality of layout planes, the initial estimated geometry comprising confidence values associated with the plurality of layout planes. Optimization accounts for low confidence and high error planes. These planes are detected and refined.

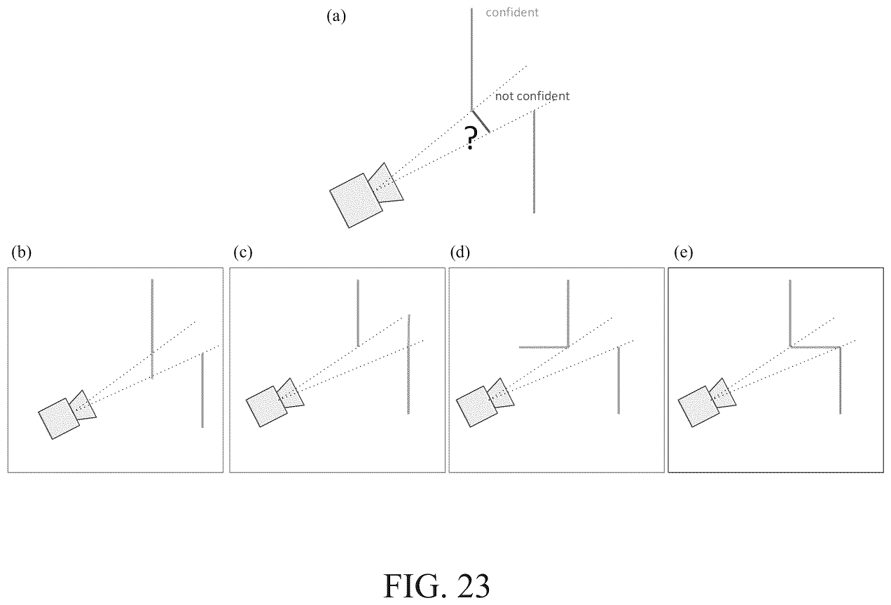

At step 2202 in FIG. 22, any layout planes in the initial estimated geometry having confidence values below a predetermined threshold can be detected and refined to generate a refined estimated geometry. As discussed above, the orientation map can provide a discrete number of normals for each plane. For plane n_i, systems and methods described herein can iterate over the set {\hat{n_i}}. However the intercept is a continuous value. Accordingly, it would not be possible to iterate through all possible values. Therefore, for intercept, only the set of intercepts which makes a plane connected to a neighbor is sampled. This selective sampling can be seen in FIG. 23, according to an exemplary embodiment. In FIG. 23, between (a) and (e), various attempts are made to minimize connectivity loss. In (e), connectivity loss is minimized as neighboring planes are connected.

An exemplary implementation can be as follows:

```
For i in (0, ..., N):
  If plane_i is confident:
    Continue
  If plane_i has no confident neighbor:
    continue
  errors = [ ]
  configs = [ ]
  For n_j in{\hat{n_i}}:
    feasible_intercepts = {..}
    For d_j in feasible_intercepts:
      errors.append(objective(n_j, d_j))
      configs.append((n_j, d_j))
  config = configs(argmin(errors))
```

At step 2203, the plurality of initial plane masks can be refined based at least in part on the refined estimated geometry to generate the plurality of optimized plane masks.

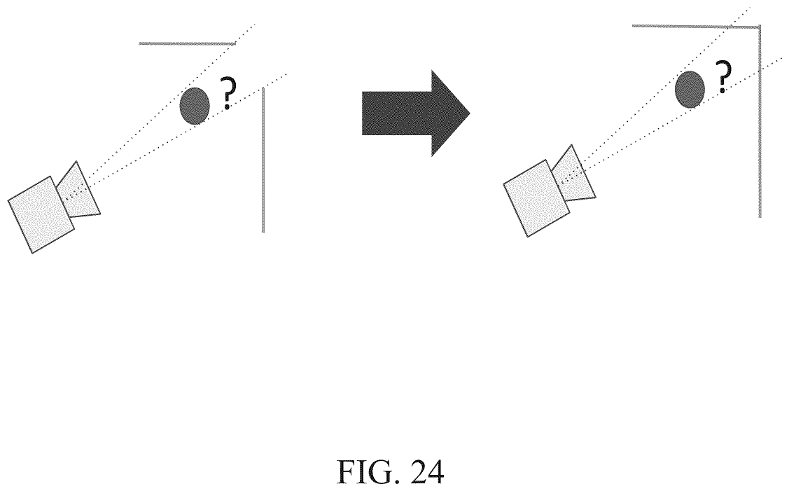

As shown in FIG. 24, according to an exemplary embodiment, scene geometry can be used to refine the initial plane masks. Neighboring planes may be orthogonal and may have an intersection. The initial plane masks can be refined to output a consistent layout in which the intersection is found, e.g., the neighboring planes are connected. The intersection can be calculated using the plane equations derived with the initial plane masks. It can be ensured that expanded planes do not violate the optimization objective.

The methods of FIGS. 22-24 can be implemented using the following exemplary optimization problem. Having extracted the initial layout planes, the corresponding 3D plane equations can be estimated. The optimization problem can be constructed that integrates depth and semantic scene priors, along with planar constraints.

The following notation and assumptions can be used:
The scene consists of N detected planes. Each plane is represented as πᵢ={maskᵢ, nᵢ, dᵢ}, where nᵢ∈R³, |nᵢ|=1 is the plane normal, and dᵢ∈R is the plane intercept. Within the optimization, the normal is represented in spherical coordinates, with fixed unit length, to ensure that it remains on the 3D rotation group SO(3). The above defined nᵢ can be the optimizable plane normal. In reality, the normal is represented in spherical coordinates {rᵢ, θ, Φᵢ}, with constant rᵢ=1. This can ensure that the normal remains on the 3D rotation group SO(3) during the optimization.
Optimization can be for the N plane equations (normal, intercept). The masks are considered fixed.
For the non-linear optimization, ρ(·) can be denoted as a properly-tuned, non-linear robust function (e.g. Huber Loss), to account for noisy input priors.
Each of the loss terms below can be accompanied by a weight.
Planes are initialized according to the depth priors.

The optimization objective can be as follows:

Objective

$$E = {\sum }_{k} {E}_{i}^{data} + {\sum }_{i , j} {w}_{i , j} {E}_{i , j}^{conn} + {\sum }_{i , j} {E}_{i , j}^{manhattan} + {\sum }_{i , j} {E}_{i}^{normal \_ smooth}$$

$${E}_{i}^{data} = {E}_{i}^{orientation} + {E}_{i}^{mvs} + {E}_{i}^{deep\_depth} + {E}_{i}^{sem \_ ace}$$

where i, j iterate over the detected planes, and the data loss is defined as:

Eᵢ^{data}=Eᵢ^{orientation}+Eᵢ^{depth}

Loss terms can include connectivity loss, photogrammetry loss, deep depth loss, orientation loss, and/or semantic occlusion loss.

Connectivity loss between planes πᵢ and πⱼ can be as follows:

$${E}_{i , j}^{conn} = {\sum }_{r ∈ \{ {r}_{k} \}} {r}^{T} ( {n}_{i} {d}_{j} - {n}_{j} {d}_{i} ) \qquad ( 2 )$$

where {rₖ} is the set of image rays lying on the boundary between the masks of planes (πᵢ, πⱼ), and w_{i,j}∈[0, 1] is the connectivity weight, indicating whether two planes are connected. The connectivity as a floating value can reflect the confidence of the prior, e.g., how certain it is that two planes are actually connected.

Manhattan loss between πᵢ and πⱼ, can be as follows:

E_{i,j}^{manhattan}=ρ(min(|nᵢ^{T}nⱼ|,|nᵢ^{T}nⱼ|−1))

The robust loss helps when planes are actually non-Manhattan (e.g., Atlanta-world), plane priors indicate they are non-manhattans but the rest of the constraints “pull” them to be, and with minor errors in image vanishing geometry.

Photogrammetry loss for πᵢ can be as follows:

$${E}_{i}^{depth} = {\sum }_{P ∈ \{ {P}_{i} \}} ρ ( {n}_{i}^{T} P + {d}_{i} )$$

where {Pᵢ} is the set of 3D points, on the image reference frame, which lie inside maskᵢ, when projected to the image.

Deep depth loss is the same as photogrammetry loss, with the only difference being that the 3D points are subsampled, since the input deep depth is dense, to get the set {Pᵢ}.

Orientation loss for πᵢ can be as follows:

$${E}_{i}^{orientation} = {\sum }_{\hat{n} ∈ \{ {\hat{n}}_{i} \}} ρ ( {n}_{i}^{T} \hat{n} - 1 ) \qquad ( 3 )$$

where {n\hat{ }i} is the set of feasible normals for plane πᵢ.

This set consists of normals voted by the scene vanishing points, as well as prior normals available (e.g. from the input depth). This set is calculated using the image orientation prior, by accumulating all the candidate normals for maskᵢ.

Semantic occlusion loss can be as follows:

$${E}_{i}^{sem \_ ace} = {\sum }_{P ∈ \{ {P}_{obj} \}} max ( 0 , exp ( {n}_{i}^{T} P + {d}_{i} ) ) + {\sum }_{P ∈ \{ {P}_{{mask}_{i}} \}} max ( 0 , exp ( {n}_{floor}^{T} unproject ( {π}_{i} , p ) + {d}_{floor} ) )$$

unproject(πᵢ, p); R²→R³ the function that unprojects a 2D point p to a 3D point P, given that it belongs to plane πᵢ.
P_{obj} is the set of 3D points belonging to non-background areas in the scene. These points can be selected using the scene semantic segmentation.
{Pₘₐₛₖᵢ} is the set of 2D points inside maskᵢ.

The first term states that the plane πᵢ, which always lies in the background because it is a layout plane, cannot be “in front” of the 3D object points. The second term states that no part of the estimated wall plane can be placed under the floor.

The plane equations can be optimized in a scene having multiple views available. The steps can:
Globally optimize for N planes viewed from K cameras, instead of 2 cameras only;
Integrate plane-to-plane connectivity and other priors as a loss term; and
Apply optimization to the planes representing the scene layout rather than the visible surfaces.

The association matrix C can be derived by using image information and prior dense normals, or line tracking, normals from a deep network, RGB and dense features from a deep network. Extending the optimization objective to multiple views can include the following steps:
N 3D planes are assumed to be available, {πᵢ}, expressed in the global frame (global planes).
Reconstruction also consists of K views, each having an intrinsic matrix Kₖ, and extrinsics Tₖ∈R [symbol] , Tₖ=[Rₖ|lₖ] (world→camera).
For each view k, Nₖ plane masks can be observed. The association Cₖ∈[0, 1]^{N}^{ₖ}^{×N}, is assumed to be available, which associates each of the Nₖ observed planes in view of k, to one of the N 3D planes. That is, cₖ[l, i]=1 if, for view k, locally detected plane l, is associated to global plane i.

$$E = {\sum }_{k ∈ \{ K \}} {E}_{k} + {\sum }_{i , j ∈ \{ N \}} {E}_{i , j}^{manhattan}$$

$${E}_{k} = {\sum }_{i ∈ \{ {N}_{k} \}} {\sum }_{i ∈ \{ N \}} {c}_{k} [ l , i ] ( {E}_{i}^{orientation} ( {\hat{H}}_{k} {n}_{k} ) + {E}_{other} ) + {\sum }_{i , j ∈ \{ N \}} {w}_{i , j}^{k} {E}_{conn} ( {transform}_{k} ( {π}_{i} ) , {transform}_{k} ( {π}_{j} ) )$$

transformₖ(πᵢ) is a function that transforms the plane equation of πᵢ from the world frame to the camera frame:

transformₖ(πᵢ)=[Rₖnᵢ,dᵢ−Rₖnᵢtₖ]

w_{i, j}^{k} is the connectivity weight of planes πᵢ, of πⱼ, as observed from camera k. That is, two world planes might be connected in 3D, but in view of k, they do not appear as such. Except for planes moving outside the field-of-view, this can happen in cases of complex ceilings, poor wall-wall estimates, and occlusions.

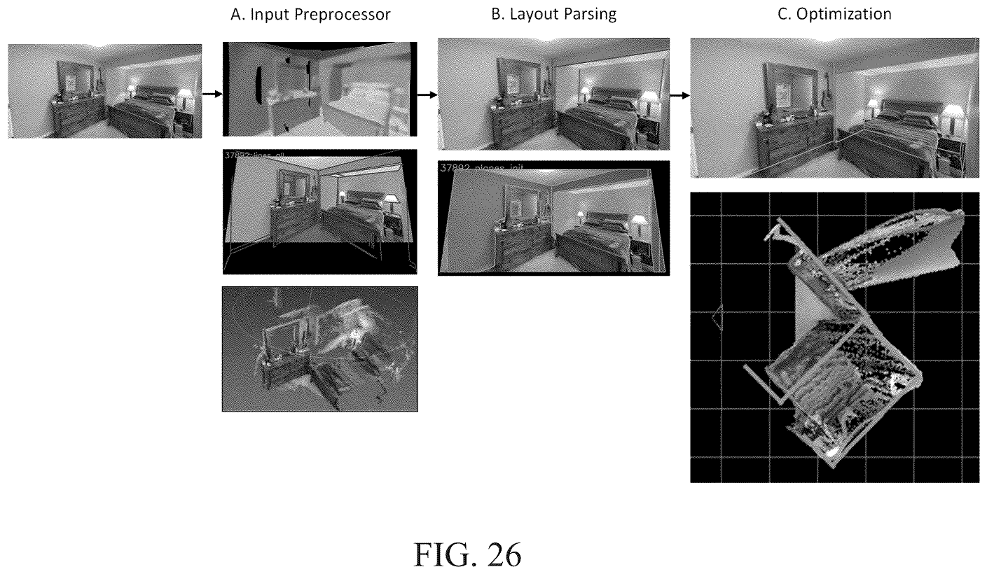

FIGS. 25-26 show the input preprocessor (FIGS. 5-14), layout parsing (FIGS. 15-19), and optimization (FIGS. 20-24) steps discussed above. As shown in the figure, the steps include:
An input preprocessor step in which the following steps are performed:
   1. Obtaining a set of images, along with pose & gravity; and
   2. Extracting perceptual information from the set of images.
A layout processing step in which the following steps are performed:
   1. Line-based layout parsing; and
   2. Estimate scene orientation priors;
An optimization step in which the following steps are performed:
   1. Initial estimate of room geometry with non-linear optimization;
   2. Detect and refine low-confident planes; and
   3. Refine plane masks using the estimated geometry.
An output assets step.

The layout processing step can generate orientation priors and/or the initial plane masks. The outputted assets represent the layout extraction of a scene for use in various applications of the systems and methods described herein. Using the techniques described herein, the layout of the scene can be modeled. User applications can include interior design, such as applying wall-hanging objects or furniture, or providing an empty room to allow reimagining of the space in the scene.

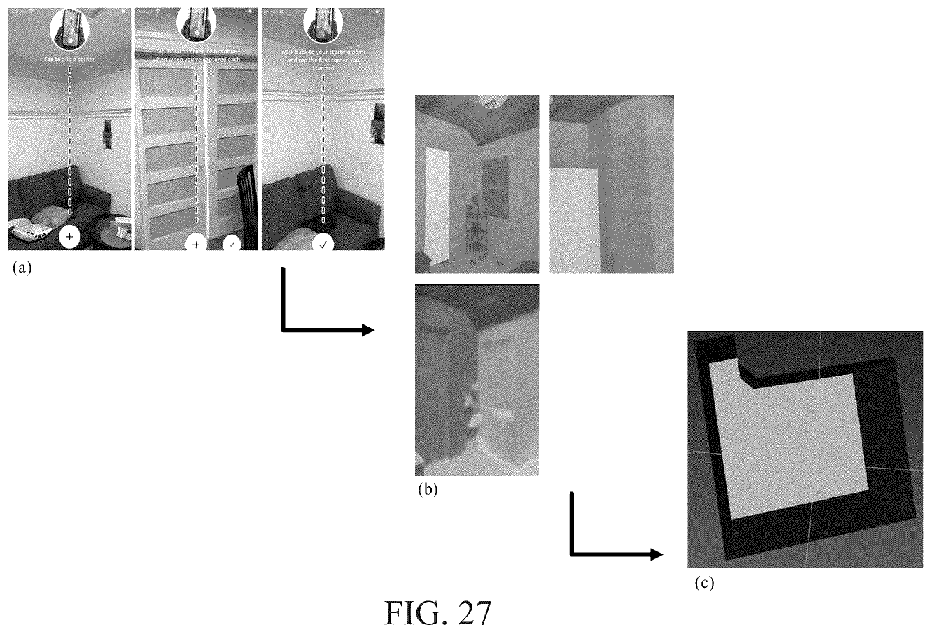

As discussed, layout extraction can be used in a variety of applications, such as interior design. The methods described herein can be implemented in a user facing system, in which a user is prompted to take one or more photo of a space showing a scene (e.g., a room in their house). With reference to FIG. 27, (a) shows an example prompt that can instruct the user to point to room corners. The user can either select walls, ceilings, floors, or corners, for example, manually, or the systems and methods described herein can detect the corners automatically. In (b), contextual, or perceptional, information can be extracted to define scene priors. In (c), the single or multiple views can be optimized to obtain an accurate layout.

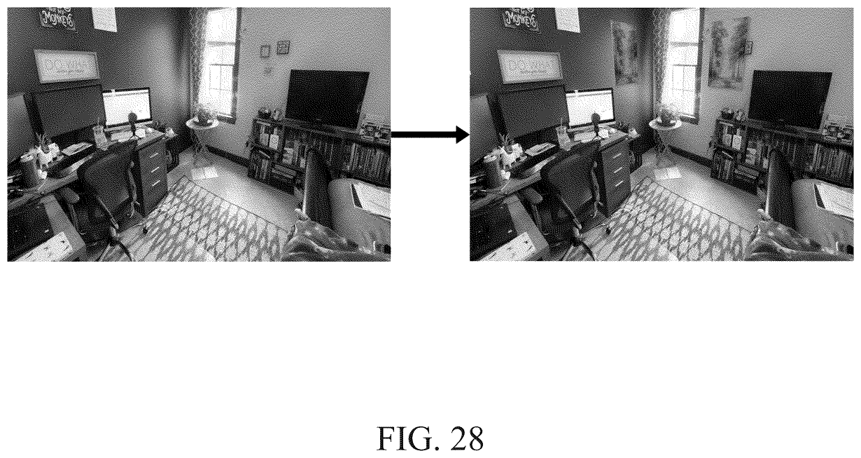

Once this modeling is complete, a user can apply virtual objects, e.g., furniture or wall-hanging objects, to the scene to simulate various interior design options, and architectural editing and planning, for example. As shown in FIG. 28, according to an exemplary embodiment, wall-hanging objects is applied to a layout of a scene to aid a user in interior design.

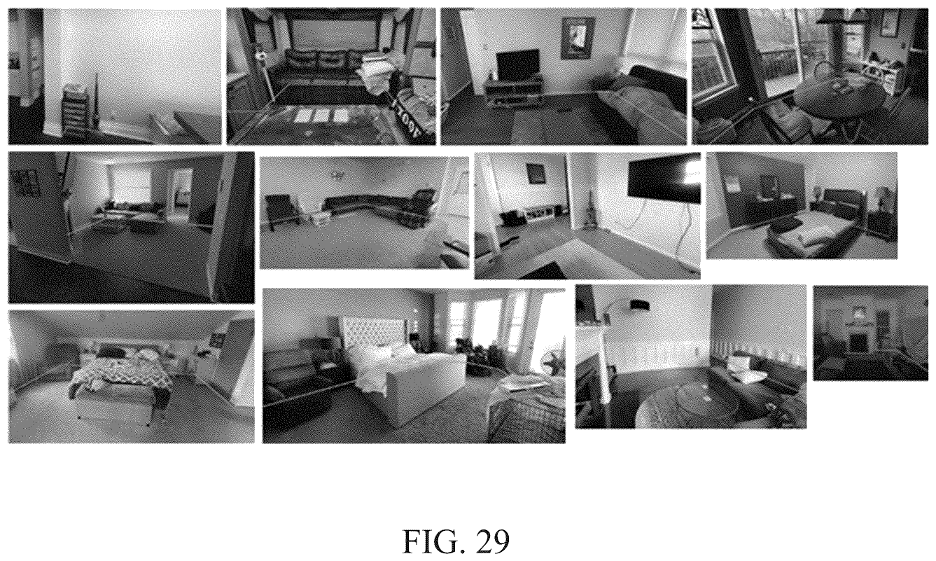

FIG. 29 shows images captured by an exemplary system to experimentally validate the effectiveness of the loss terms.

A dataset of 250 wide-angle photographs from homes was gathered, captured from a viewpoint that maximizes the scene visibility. A specialized tool annotated the room layout, e.g., the ground truth floor-wall boundary, even in challenging environments (e.g., kitchens).

Wall-floor edge error was evaluated, where the error can effectively measure the accuracy of the layout in 2D. The error does not need to find correspondences between predicted and ground truth planes.

The results were evaluated against Render-And-Compare (RnC), an example existing system. For both systems, the same semantic segmentation and dense depth from a deep network as inputs (no LiDAR) were used, to allow for comparison. The present system utilized line segments from LCNN directly.

The following Table 1 shows the quantitative results for the wall-floor (W-F) edge loss. RnC is tested with PlaneRCNN, a existing system, as an input, as well as PlaneTR, the state-of-the-art piecewise planar reconstruction method. Since the present system uses semantic segmentation to carve out plane instances, PlaneTR plane masks were post-processed with semantic segmentation, to make for a more fair comparison of the two methodologies. Ablation studies were also included, to demonstrate the importance of the optimization losses used.

TABLE 1

| Method | W-F edge error (pxl) ↓ |
|---|---|
| RnC + PlaneRCNN | 29.32 |
| RnC + PlaneTR | 20.51 |
| RnC + PlaneTR + semantic | 14.79 |
| segmentation | |
| The present system, no | 9.30 |
| vanishing point-normals | |
| The present system, no wall- | 8.96 |
| wall connectivity | |
| The present system-full | 7.67 |

Quantitative results of the present system's in-house dataset, comparing the present method against RnC under various configurations, for the wall-floor (W-F) edge pixel loss. The arrow-down symbol indicates “lower is better”. For PlaneTR with semantic segmentation, the input plane masks are refined using semantic segmentation. The ablation studies show the importance of the wall-wall connectivity term, and the orientation loss.

As shown, using the same input priors, the present method significantly outperforms the previous state-of-the-art, on the challenging in-house dataset. It can be seen that the plane segmentation quality has a detrimental effect on the results as current methods have trouble generating precise masks for small wall segments with severe occlusions, which is not a problem for the layout approaches.

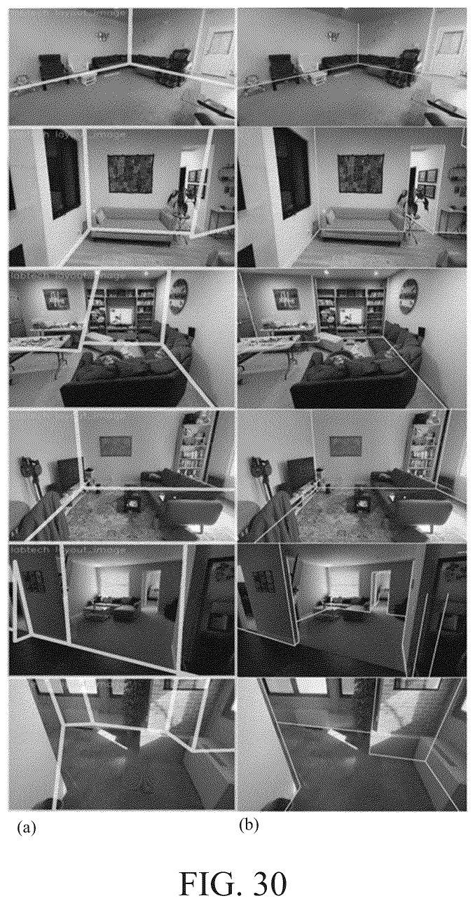

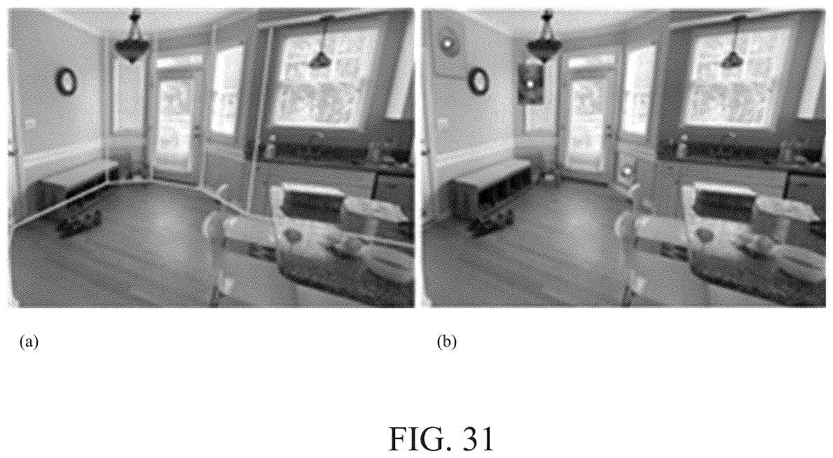

Qualitative comparisons are also shown in FIG. 30 with (a) showing the existing system and (b) showing the present system results. As shown in (b), the present system allows for wall art, or other wall object, applications, with more accurate modeling of room surfaces, as shown in FIG. 31. In (a), the scene is modeled. Accordingly, in (b), a wall art can be applied.

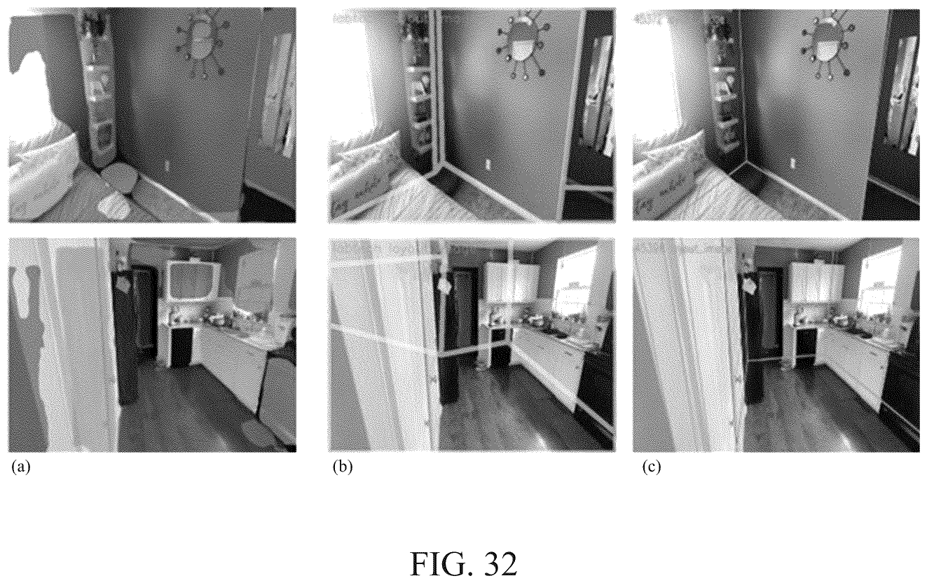

FIG. 32 shows another exemplary system validation in comparison to existing. Example executions from existing are shown in (a) and (b). The present system results are shown in (c).

As shown, mask-based planar segmentation methods face no problem when a wall plane is clearly visible without occlusions (top row). But precise boundary estimation becomes challenging under severe occlusions, resulting in less accurate estimate layout by the existing (bottom row). The present system estimates precise layout plane boundaries, which can be used to enforce reliable connectivity constraints between planes and get an accurate layout reconstruction, shown in (c).

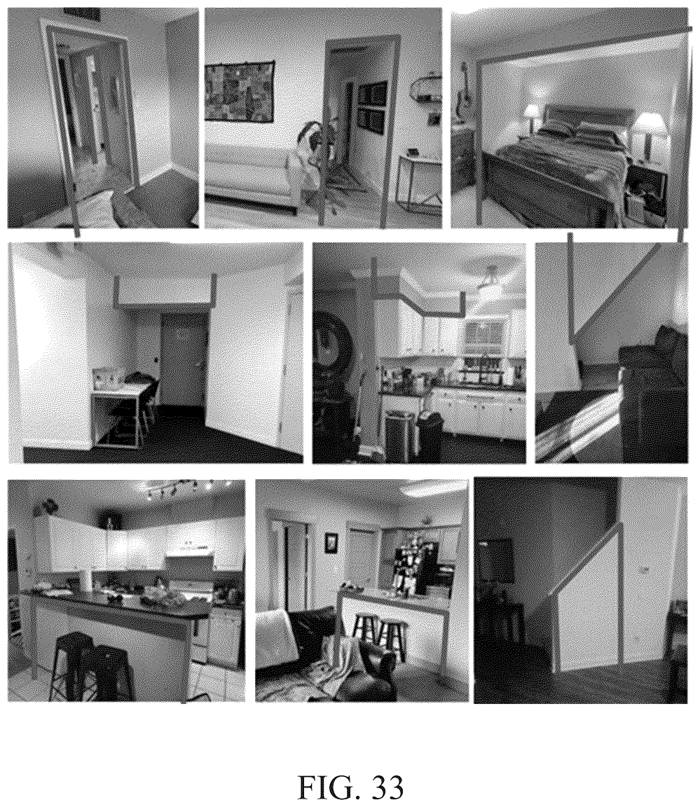

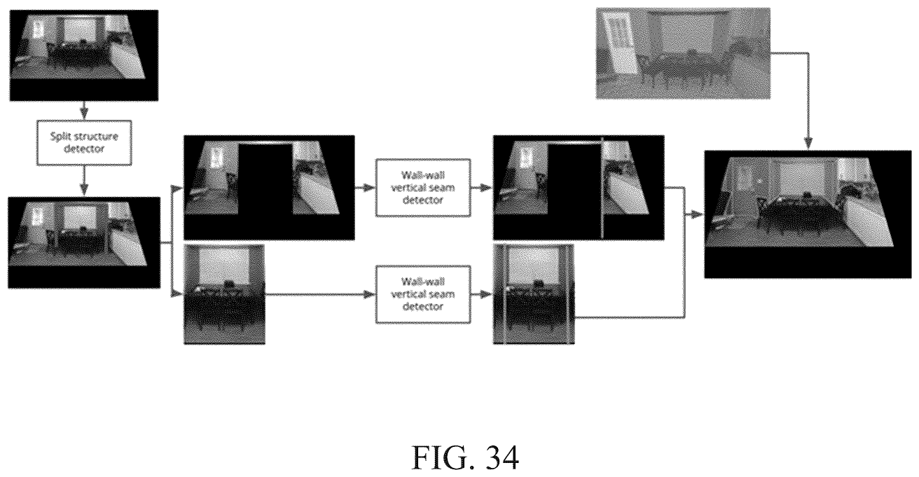

FIGS. 33-34 show examples of modeling complex geometries, according to exemplary embodiments. FIG. 33 shows split structures and walls that do not span from a ceiling-floor. These walls can be proximate to split structures that violate the vertical separation of wall planes. As shown, split structures can refer to openings, soffits, or counters. FIG. 34 shows a method of detecting split structures and vertical wall-wall seams for each of these areas, according to an exemplary embodiment. The final masks can be produced by superimposing semantic segmentation and keeping only the wall pixels. The initial image can be assumed to be vertically rectified, to make the vertical seam detection easier.

FIG. 35 illustrates a flowchart of a method 3500 for layout extraction according to an exemplary embodiment. The method can be performed on a server that interfaces with a client and having sufficient computing resources to perform the graphics, modeling, and machine learning tasks described herein. Alternatively, the method can be performed on a client device having sufficient resources or performed on a computing device or set of computing devices outside of a client-server system. Method 3500 can be similar to method 400 (FIG. 4) and/or method 3600 (FIG. 36), and can include one or more steps from method 400 and/or method 3600.

At step 3501, a plurality of scene priors corresponding to an image of a scene can be stored. The plurality of scene priors can include a semantic map indicating semantic labels associated with a plurality of pixels in the image, geometry information corresponding to the plurality of pixels in the image, and one or more line segments corresponding to the scene. Step 3501 can be similar to step 401 (FIG. 4) and can include one or more aspects of step 401.

The image can be an RGB image. The semantic labels can include at least one of a wall, a ceiling, or a floor. The scene priors can include one or more of a gravity vector corresponding to the scene; an edge map corresponding to a plurality of edges in the scene; a normal map corresponding to a plurality of normals in the scene; camera parameters of a camera configured to capture the image; or an orientation map corresponding to a plurality of orientation values in the scene. The geometry information can include one or more of a depth map corresponding to the plurality of pixels; photogrammetry points corresponding to a plurality of three-dimensional point values in the plurality of pixels; a sparse depth map corresponding to the plurality of pixels; a plurality of depth pixels storing both color information and depth information; a mesh representation corresponding to the plurality of pixels; a voxel representation corresponding to the plurality of pixels; or depth information associated with one or more polygons corresponding to the plurality of pixels.

At step 3502, one or more borders based on the one or more line segments can be generated. Each border can represent a separation between two layout planes in a plurality of layout planes of the scene. Step 3502 can be similar to step 402 (FIG. 4) and can include one or more aspects of step 402.

The plurality of layout planes can include at least one of a planar plane or a curved plane. Step 3502 can include detecting a horizontal line from a pixel of the plurality of pixels in the image; calculating a vanishing point based on the horizontal line and a gravity vector associated with the pixel; and combining the vanishing point with the gravity vector to determine a plurality of normal estimates. Additionally or alternatively, step 3502 can include detecting a first set of borders comprising lines that form seams between two walls; detecting a second set of borders comprising lines that separate walls in the scene; and detecting a third set of borders comprising lines that separate walls from floors or ceilings in the scene. The detecting the first set of borders can include lines that form seams between two walls determining a first end and a second end of the line segment; and determining whether the line segment forms a seam between two walls based at least in part on the first end and the second end and a normal map of the scene.

At step 3503, a plurality of plane masks corresponding to the plurality of layout planes that estimate the geometry of the scene can be generated. The plurality plane masks can be based at least in part on at least one of the plurality of scene priors and the one or more borders. Step 3503 can be similar to steps 402 and 403 (FIG. 4) and can include one or more aspects of steps 402 and 403.

Step 3503 can include generating a plurality of initial plane masks, the plurality of initial plane masks corresponding to the plurality of layout planes; generating a plurality of plane connectivity values based at least in part on the one or more borders, each plane connectivity value indicating connectivity between two layout planes in the plurality of layout planes; and refining the plurality of initial plane masks based at least in part on an estimated geometry of the plurality of layout planes, the estimated geometry based at least in part on at least one of at least one of the plurality of scene priors, the plurality of initial plane masks, and the plurality of connectivity values. The generating the plurality of initial plane masks and the plurality of plane connectivity values based at least in part on the plurality of borders can include superimposing the semantic map on the plurality of borders to select for pixels corresponding to the plurality of layout planes of the scene. The refining the plurality of initial plane masks based at least in part on an estimated geometry of the plurality of layout planes can include applying a non-linear optimization function based at least in part on the plurality of initial plane masks, the plurality of connectivity values, and at least one of the one or more scene priors to generate an initial estimated geometry of the plurality of layout planes, the initial estimated geometry comprising confidence values associated with the plurality of layout planes; detecting and refining one or more low confidence layout planes in the plurality of layout planes in the initial estimated geometry having confidence values below a predetermined threshold to generate a refined estimated geometry; and refining the plurality of initial plane masks based at least in part on the refined estimated geometry to generate the plurality of plane masks.

Method 3500 can optionally include step 3504, at which one or more three-dimensional (3D) plane parameters corresponding to the plurality of layout planes that estimate the geometry of the scene can be generated. Step 3504 can be similar to steps 402 and 403 (FIG. 4) and can include one or more aspects of steps 402 and 403.

FIG. 36 illustrates a flowchart of a method 3600 for layout extraction according to an exemplary embodiment. The method can be performed on a server that interfaces with a client and having sufficient computing resources to perform the graphics, modeling, and machine learning tasks described herein. Alternatively, the method can be performed on a client device having sufficient resources or performed on a computing device or set of computing devices outside of a client-server system. Method 3600 can be similar to method 400 (FIG. 4) and/or method 3500 (FIG. 35), and can include one or more steps from method 400 and/or method 3500.

At step 3601, a first scene prior and a second scene prior corresponding to an image of a scene can be stored. The image can be of one or more corners in the scene. The first scene prior and the second scene prior can include a semantic map indicating semantic labels associated with a plurality of pixels in the image and geometry information corresponding to the plurality of pixels in the image. Step 3501 can be similar to step 401 (FIG. 4) and can include one or more aspects of step 401.

The image can be one of a plurality of images of the scene. The first scene prior and the second scene prior can correspond to the plurality of images of the scene. The semantic map can indicate semantic labels is associated with a plurality of pixels in the plurality of images. The first scene prior and the second scene prior each can include one or more of a gravity vector corresponding to the scene; an edge map corresponding to a plurality of edges in the scene; a normal map corresponding to a plurality of normals in the scene; camera parameters of a camera configured to capture the image; or an orientation map corresponding to a plurality of orientation values in the scene. The geometry information can include one or more of a depth map corresponding to the plurality of pixels; photogrammetry points corresponding to a plurality of three-dimensional point values in the plurality of pixels; a sparse depth map corresponding to the plurality of pixels; a plurality of depth pixels storing both color information and depth information; a mesh representation corresponding to the plurality of pixels; a voxel representation corresponding to the plurality of pixels; or depth information associated with one or more polygons corresponding to the plurality of pixels.

At step 3602, one or more borders based on at least one of the first scene prior or the second scene prior can be generated. Each border can represent a separation between two layout planes in a plurality of layout planes of the scene. Step 3502 can be similar to step 402 (FIG. 4) and can include one or more aspects of step 402.

At step 3603, a plurality of plane masks corresponding to the plurality of layout planes that estimate a geometry of the scene can be generated. The plurality plane masks can be based at least in part on the one or more borders. Step 3503 can be similar to steps 402 and 403 (FIG. 4) and can include one or more aspects of steps 402 and 403. The generating a plurality of plane masks corresponding to the plurality of layout planes that estimate the geometry of the scene can include applying a non-linear optimization function based at least in part on at least one of the one or more scene priors.

Method 3600 can optionally include step 3604, at which one or more three-dimensional plane (3D) parameters corresponding to the plurality of layout planes that estimate the geometry of the scene can be generated. Step 3504 can be similar to steps 402 and 403 (FIG. 4) and can include one or more aspects of steps 402 and 403.

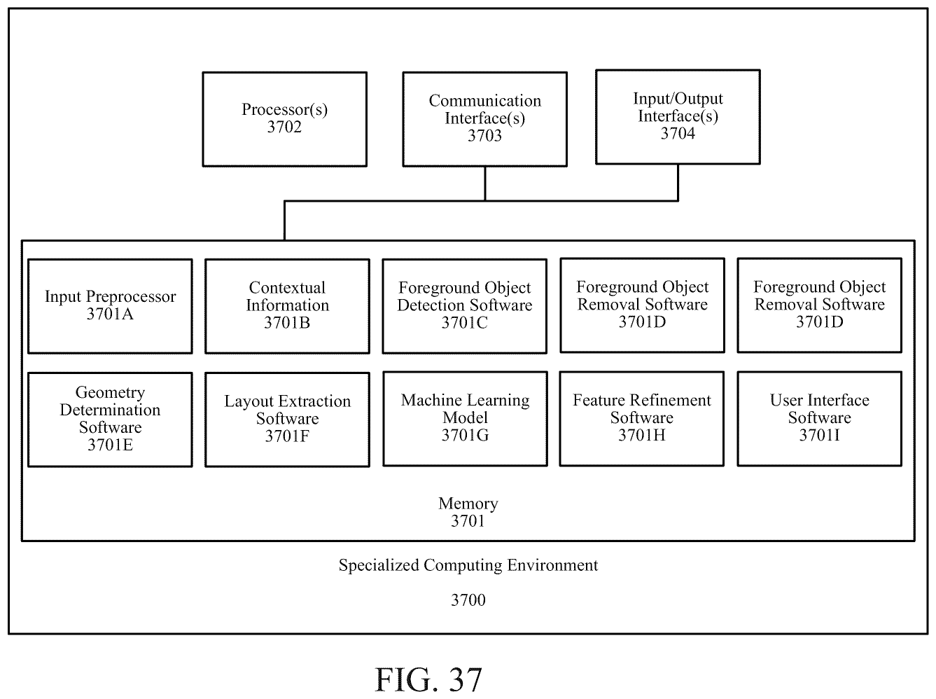

FIG. 37 illustrates the components of a specialized computing environment 3700 configured to perform the specialized processes described herein. Specialized computing environment 3700 is a computing device that includes a memory 3701 that is a non-transitory computer-readable medium and can be volatile memory (e.g., registers, cache, RAM), non-volatile memory (e.g., ROM, EEPROM, flash memory, etc.), or some combination of the two.

As shown in FIG. 37, memory 3701 can include input preprocessor 3701A, contextual information 3701B, foreground object detection software 3701C, foreground object removal software 3701D, geometry determination software 3701E, layout extraction software 3701F, machine learning model 3701G, feature refinement software 3701H, and/or user interface software 3701I.

All of the software stored within memory 3701 can be stored as a computer-readable instructions, that when executed by one or more processors 3702, cause the processors to perform the functionality described with respect to FIGS. 1-36.

Processor(s) 3702 execute computer-executable instructions and can be a real or virtual processors. In a multi-processing system, multiple processors or multicore processors can be used to execute computer-executable instructions to increase processing power and/or to execute certain software in parallel.

Specialized computing environment 3700 additionally includes a communication interface 3703, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 3700 further includes input and output interfaces 1304 that allow users (such as system administrators) to provide input to the system to set parameters, to edit data stored in memory 3701, or to perform other administrative functions.

An interconnection mechanism (shown as a solid line in FIG. 29), such as a bus, controller, or network interconnects the components of the specialized computing environment 3700.

Input and output interfaces 3704 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 3700.

Specialized computing environment 3700 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 3700.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure.

What is claimed is:

1. A method executed by one or more computing devices for layout extraction, the method comprising:
storing a plurality of scene priors corresponding to an image of a scene, the plurality of scene priors comprising a semantic map indicating semantic labels associated with a plurality of pixels in the image, geometry information corresponding to the plurality of pixels in the image, and one or more line segments corresponding to the scene;
generating one or more borders based on the one or more line segments, each border representing a separation between two layout planes in a plurality of layout planes of the scene; and
generating a plurality of plane masks corresponding to the plurality of layout planes that estimate the geometry of the scene, the plurality plane masks based at least in part on at least one of the plurality of scene priors and the one or more borders.

2. The method of claim 1, wherein the plurality of layout planes comprise at least one of a planar plane or a curved plane.

3. The method of claim 1, wherein the semantic labels comprise at least one of a wall, a ceiling, or a floor.

4. The method of claim 1, wherein the image is a red-green-blue (RGB) image.

5. The method of claim 1, wherein the plurality of scene priors further comprises one or more of:
a gravity vector corresponding to the scene;
an edge map corresponding to a plurality of edges in the scene;
a normal map corresponding to a plurality of normals in the scene;
camera parameters of a camera configured to capture the image; or
an orientation map corresponding to a plurality of orientation values in the scene.

6. The method of claim 1, wherein the geometry information comprises one or more of:
a depth map corresponding to the plurality of pixels;
photogrammetry points corresponding to a plurality of three-dimensional point values in the plurality of pixels;
a sparse depth map corresponding to the plurality of pixels;
a plurality of depth pixels storing both color information and depth information.
a mesh representation corresponding to the plurality of pixels;
a voxel representation corresponding to the plurality of pixels; or
depth information associated with one or more polygons corresponding to the plurality of pixels.

7. The method of claim 1, wherein generating one or more borders based on the one or more line segments comprises computing an orientation map by:
detecting a horizontal line from a pixel of the plurality of pixels in the image;
calculating a vanishing point based on the horizontal line and a gravity vector associated with the pixel; and
combining the vanishing point with the gravity vector to determine a plurality of normal estimates.

8. The method of claim 1, wherein generating one or more borders based on the one or more line segments comprises:
detecting a first set of borders comprising lines that form seams between two walls;
detecting a second set of borders comprising lines that separate walls in the scene; and
detecting a third set of borders comprising lines that separate walls from floors or ceilings in the scene.

9. The method of claim 8, wherein the detecting the first set of borders comprising lines that form seams between two walls comprises, for each line segment in the one or more line segments:
determining a first end and a second end of the line segment; and
determining whether the line segment forms a seam between two walls based at least in part on the first end and the second end and a normal map of the scene.

10. The method of claim 1, wherein the generating a plurality of plane masks corresponding to the plurality of layout planes that estimate the geometry of the scene comprises:
generating a plurality of initial plane masks, the plurality of initial plane masks corresponding to the plurality of layout planes;
generating a plurality of plane connectivity values based at least in part on the one or more borders, each plane connectivity value indicating connectivity between two layout planes in the plurality of layout planes; and
refining the plurality of initial plane masks based at least in part on an estimated geometry of the plurality of layout planes, the estimated geometry based at least in part on at least one of at least one of the plurality of scene priors, the plurality of initial plane masks, and the plurality of connectivity values.

11. The method of claim 10, wherein the generating the plurality of initial plane masks and the plurality of plane connectivity values based at least in part on the plurality of borders comprises:
superimposing the semantic map on the plurality of borders to select for pixels corresponding to the plurality of layout planes of the scene.

12. The method of claim 10, wherein the refining the plurality of initial plane masks based at least in part on an estimated geometry of the plurality of layout planes comprises:
applying a non-linear optimization function based at least in part on the plurality of initial plane masks, the plurality of connectivity values, and at least one of the one or more scene priors to generate an initial estimated geometry of the plurality of layout planes, the initial estimated geometry comprising confidence values associated with the plurality of layout planes;
detecting and refining one or more low confidence layout planes in the plurality of layout planes in the initial estimated geometry having confidence values below a predetermined threshold to generate a refined estimated geometry; and
refining the plurality of initial plane masks based at least in part on the refined estimated geometry to generate the plurality of plane masks.

13. A method executed by one or more computing devices for layout extraction, the method comprising:
storing a first scene prior and a second scene prior corresponding to an image of a scene, the first scene prior and the second scene prior comprising a semantic map indicating semantic labels associated with a plurality of pixels in the image and geometry information corresponding to the plurality of pixels in the image;
generating one or more borders based on at least one of the first scene prior or the second scene prior, each border representing a separation between two layout planes in a plurality of layout planes of the scene; and
generating a plurality of plane masks corresponding to the plurality of layout planes that estimate a geometry of the scene, the plurality plane masks based at least in part on the one or more borders.

14. The method of claim 13, wherein the image is one of a plurality of images of the scene,
wherein the first scene prior and the second scene prior correspond to the plurality of images of the scene, and
wherein the semantic map indicating semantic labels is associated with a plurality of pixels in the plurality of images.

15. The method of claim 13, wherein the first scene prior and the second scene prior each comprises one or more of:
a gravity vector corresponding to the scene;
an edge map corresponding to a plurality of edges in the scene;
a normal map corresponding to a plurality of normals in the scene;
camera parameters of a camera configured to capture the image; or
an orientation map corresponding to a plurality of orientation values in the scene.

16. The method of claim 13, wherein the geometry information comprises one or more of:
a depth map corresponding to the plurality of pixels;
photogrammetry points corresponding to a plurality of three-dimensional point values in the plurality of pixels;
a sparse depth map corresponding to the plurality of pixels;
a plurality of depth pixels storing both color information and depth information.
a mesh representation corresponding to the plurality of pixels;
a voxel representation corresponding to the plurality of pixels; or
depth information associated with one or more polygons corresponding to the plurality of pixels.

17. The method of claim 13, wherein the image is of one or more corners in the scene.

18. The method of claim 13, wherein the generating a plurality of plane masks corresponding to the plurality of layout planes that estimate the geometry of the scene comprises:
applying a non-linear optimization function based at least in part on at least one of the one or more scene priors.

19. The method of claim 13, further comprising:
generating one or more three-dimensional (3D) plane parameters corresponding to the plurality of layout planes that estimate the geometry of the scene.

20. A method executed by one or more computing devices for layout extraction, the method comprising:
storing a plurality of scene priors corresponding to an image of a scene, the plurality of scene priors comprising a semantic map indicating semantic labels associated with the plurality of pixels in the image and a plurality of line segments;
detecting a plurality of borders in the scene based at least in part on one or more of the plurality of scene priors, each border representing a separation between two layout planes in a plurality of layout planes, wherein each layout plane comprises a wall plane, a ceiling plane, or a floor plane;
generating a plurality of initial plane masks and a plurality of plane connectivity values based at least in part on the plurality of borders, wherein the plurality of initial plane masks correspond to the plurality of layout planes and wherein each plane connectivity value indicates connectivity between two layout planes in the plurality of layout planes; and
generating a plurality of optimized plane masks by refining the plurality of initial plane masks based at least in part on an estimated geometry of the plurality of layout planes, wherein the estimated geometry is determined based at least in part on one or more of the plurality of scene priors, the plurality of initial plane masks, and the plurality of connectivity values.
